(19) United States
(12) Patent Application Publication
(10) Pub. No.: US 2008/0033744 A1
(43) Pub. Date: Feb. 7, 2008

(54) METHOD, SYSTEM, AND COMPUTER PROGRAM PRODUCT FOR MULTI-LEVEL MARKETING

(75) Inventor: Scott A. Jones, Carmel, IN (US)

Correspondence Address: STAAS & HALSEY LLP, SUITE 700, 1201 NEW YORK AVENUE, N.W., WASHINGTON, DC, 20005, US

(73) Assignee: ChaCha Search, Inc., Carmel, IN (US)

(21) Appl. No.: 11/835,080

(22) Filed: Aug. 7, 2007

Related U.S. Application Data
(60) Provisional application No. 60/821,647, filed on Aug. 7, 2006.

(51) Int. Cl. G06Q 30/00

(52) U.S. Cl. 705/1

(57) ABSTRACT

A method and system of multi-level marketing including automatically sharing income between at least one intermediate marketing level including at least one for-profit entity, a middle level including at least one non-profit entity, and at least one lower level including a mixture of non-profit entities and for-profit entities. The for-profit entities can share a portion of or all of their income with non-profit entities such as charitable organizations. The various entities in the system can serve as sponsors to other entities.

### CROSS-REFERENCE TO RELATED APPLICATION

This application is related to and claims the benefit of Provisional Application U.S. Ser. No. 60/821,647, Attorney Docket No. 1918.1013P, entitled METHOD, SYSTEM, AND COMPUTER PROGRAM PRODUCT FOR MULTI-LEVEL MARKETING, by Scott A. Jones, filed Aug. 7, 2006 and is related to Application U.S. Ser. No. 11/336,928, Attorney Docket Number 1918.1001, entitled A SCALABLE SEARCH SYSTEM USING HUMAN SEARCHERS, by Scott A. Jones, filed on Jan. 23, 2006, in the U.S. Patent and Trademark Office, the contents of all of the above-identified applications are incorporated herein by reference.

### BACKGROUND

### Description of the Related Art

1. Field

The embodiments described herein relate, generally, to marketing systems and methods, and more particularly to multi-level marketing systems and methods.

2. Description of the Related Art

Multi-level marketing methods have existed for many years, often providing for marketing and distribution of physical goods. The Internet has enabled new methods of communication and workflow for multi-level marketing businesses.

More recently, there have been new methods of performing work tasks using the Web, sometimes distributing the tasks among numerous workers or volunteers, as for example with Amazon® Mechanical Turk.

However, it has not been obvious or demonstrated how to successfully apply multi-level marketing methods to web-based models that properly amplify the benefits of web-based work tasks combined with multi-level marketing techniques.

Additionally, in a traditional multi-level marketing plan, there are typically several “for profit” entities (oftentimes individuals) cooperating together. However, many non-profit organizations also utilize multi-level marketing methods for fundraising purposes. For example, Girl Scouts of the United States of America typically conducts annual cookie sales. The organization utilizes a multi-level marketing system having several layers. For example, the first layer includes corporate office, the second layer includes the regional offices, and the third level includes the Girl Scout members.

There are also well-known practices of having various charitable organizations depend upon the American Red Cross for support. The Red Cross, a charitable organization itself, solicits contributions from corporations as a primary activity and then redistributes funds to its various participating charitable organizations. The corporations that are solicited for contributions often enlist the help of their employees to solicit contributions from friends, family, and associates and may supplement those contributions (e.g., corporate matching).

Regardless of the structure of the system, commonly each of the entities at the various levels is, homogenously, either individuals, non-profit entities or for-profit entities, for example. Opportunity is not provided for individuals or organizations to gain additional earnings for themselves in addition to contributing funds to a particular non-profit based upon work that may be accomplished. Although previously known multi-level marketing systems can be effective in accomplishing marketing and sales objectives, one of the problems with such systems is that the systems do not have the potential to reach the greatest possible participation among diverse combinations of individuals, for-profit, and non-profit entities or organizations.

In light of the foregoing, what is needed is a multi-level marketing system which allows the inclusion of a mixture of individuals, non-profit entities, and for-profit entities, in a heterogeneous combination, thereby increasing overall participation and income by using such a system to accomplish a more pervasive approach to marketing, especially when applied to web-based work tasks.

### SUMMARY

The embodiments described herein are directed to methods, processes, data structures, and systems relating to multi-level marketing, accessed via the Internet (or any other network) and relating to work tasks which may be accomplished by a multiplicity of human workers operating over a network (e.g., the Internet). An embodiment of the system includes automatically allocating compensation to a “sponsoring” entity (which may be an individual, a for-profit entity, or a not-for-profit entity) based upon the recruitment of and/or the performance of at least one “sponsored” entity (which may likewise be an individual, a for-profit entity, or a not-for-profit entity) that is receiving compensation. The sponsored entity may allocate some or all of its own compensation to the sponsoring entity or to one or more other entities (any of which may be an individual, a for-profit entity, or a not-for-profit entity), any of which may be referred to as a donee (in which case the sponsored entity becomes a donor). The compensation for the sponsoring entity may be affected by the performance of the sponsored entity and/or other factors.

This flexible, yet highly structured, system creates an advantageous business equation for motivating and providing incentives for both sponsoring and sponsored entities to perform quality work, to maximize work performed and to sponsor new entities.

The system also creates incentives for-profit entities, not-for-profit entities, and individuals to sign-up workers and/or entities into their “network” so that income may be earned for one or more parties. Sponsors are typically provided incentives to recruit entities that will perform well either by doing work directly or by recruiting a large network of those who will perform work.

In at least one embodiment, in an information search system where the work to be performed is information searching on behalf of an information seeker(s), an option is presented allowing a human searcher (the worker) to register to do work (searching) based upon an invitation from a sponsor (which may or may not also be a human searcher). In addition, the human searcher may allocate none, some, or all of his or her compensation to the sponsor and/or to one or more other individuals, for-profit entities, or not-for-profit entities.

### BRIEF DESCRIPTION OF THE DRAWINGS

These together with other aspects and advantages which will be subsequently apparent, reside in the details of construction and operation as more fully hereinafter described and claimed, reference being made to the accompanying drawings forming a part hereof, wherein like numerals refer to like parts throughout.

FIG. 1 is an illustration of a multi-level marketing system.

FIG. 2 depicts a system architecture embodiment.

FIG. 3 is a representation of a donee/donor record.

FIG. 4 is a representation of a sponsoree/sponsor record.

FIG. 5 is a flow diagram of associating a worker with a sponsor;

FIG. 6 is a flow diagram of tracking and recording sponsor and donor activities in a multi-level marketing system.

FIG. 7 is an illustration of a multi-level marketing system utilized in conjunction with an information search system employing human searchers.

FIG. 8 is a system diagram of a multi-level marketing management system.

FIG. 9 is a flow diagram of a method for providing multi-level marketing in an online system.

FIG. 10 is a block diagram illustrating sponsorship in an information search system.

FIG. 11 is a flow diagram of a method for providing multi-level marketing in an information search system employing human searchers.

FIG. 12 is an illustration of a multi-level marketing system utilized in conjunction with an information search system employing human searchers.

FIG. 13 is a representation of a donee record.

FIG. 14 is a representation of a donor record.

FIG. 15 is an illustration of a search results page including links facilitating registration as member of the multi-level market system and contributions to donees.

FIG. 15A is an exemplary search results page of an affiliated member.

FIG. 16 is an illustration of a sponsoree/donor election graphical user interface (GUI).

FIG. 17 is an illustration of a sponsor/donee review GUI.

### DETAILED DESCRIPTION OF THE PREFERRED EMBODIMENTS

Reference will now be made in detail to the embodiments, examples of which are illustrated in the accompanying drawings, wherein like reference numerals refer to like elements throughout.

As used herein a “donee” is an entity that may benefit by receiving contributions from an income-producing member of the multi-level marketing system regardless of whether the donee sponsored the entry of the income-producing member into the multi-level marketing system. In some embodiments of the disclosed method, donees may be limited to entities that are members of the multi-level marketing system. In other embodiments, donees may be entities that meet certain criteria, such as being a registered non-profit or other charitable organization that has agreed to maintain a link on their webpage or to otherwise promote membership in the multi-level marketing system. In other embodiments, the donee may be any entity willing to receive contributions regardless of the for-profit or not-for-profit (also referred to as non-profit) status of the entity. For example, parents of a student at a university who are income-producing members of the multi-level marketing system may elect to contribute a percentage of their income generated by the underlying activities supporting the multi-level marketing system to their student child, who might be an income-producing member. Thus, those of ordinary skill in the relevant art upon reading this disclosure will recognize, that while the term “donee” is utilized herein to identify entities that are designated to receive a share of income generated by a member entity of the multi-level marketing system, the contribution need not qualify as a charitable contribution or gift and the donee need not be a charitable or non-profit organization unless otherwise specifically designated as such.

In one specific embodiment of the disclosed system and method, any entity organized as a 501(c)(3) organization may be a donee regardless of whether such entity is a member of or has any direct or indirect involvement in the multi-level marketing system. In another specific embodiment, only 501(c)(3) organizations that promote membership in the multi-level marketing system by other entities meet the criteria to be considered a donee. In such an embodiment, the 501(c)(3) organization may include a link on the organization's website promoting the multi-level marketing system or membership therein or may provide sponsorship codes on business cards and other literature and URLs or e-mails or instant message or chat sessions or other indications as to how to register as a member of the multi-level marketing system.

As used herein a “sponsor” is an entity that facilitates a new entity becoming a member of the multi-level marketing system. In at least one embodiment, sponsorship implies that the sponsoring entity may receive mandatory compensation based upon a percentage of the income generated by the entity that was sponsored for membership. This compensation might derive from the sponsored entity itself or from the system implementing the embodiment. In at least one embodiment, the level of compensation for the sponsor is determined by the performance of the sponsored entity, but the compensation is paid by the system that is accumulating revenues based on revenue sources such as online advertising.

At least one embodiment is directed to a method and system of multi-level marketing, accessed via the Internet (or any network) and relating to work tasks which may be accomplished by human workers operating over the network, including automatically allocating compensation to a “sponsoring” management entity, also referred to herein as a “sponsor”, (which may be an individual, a for-profit entity, or a not-for-profit entity) based upon the performance of at least one “sponsored” entity, also referred to as a “sponsoree”, (which may be an individual, a for-profit entity, or a not-for-profit entity) that may also be receiving compensation. Any portion of the compensation for the sponsor may be affected by the performance of the sponsoree, i.e., there may be a fee or bonus compensation directed to the sponsor in return for the sponsor having “signed-up” the sponsoree. In addition, the sponsoree may allocate some or all of its own compensation to the sponsor or to one or more other entities (any of which may be an individual, a for-profit entity, or a not-for-profit entity), any of which may be referred to herein as a “donee” (and in such case, the sponsoree is also a “donor”).

This flexible, yet highly structured, system creates an advantageous business equation for motivating and providing incentives for both sponsoring and sponsored entities to perform work and to sponsor new entities to become members of the system.

At least one embodiment also creates incentives for-profit entities, not-for-profit entities, and individuals to sign-up workers and/or entities into their “network” so that compensation may be earned. Sponsors are typically incentivized to sign-up entities that will perform well either by doing work directly or by signing up a network of those who will perform work.

In at least one embodiment, in an information search system where the work to be performed is searching on behalf of an information seeker, an option is presented allowing a human searcher (the worker) to sign-up to do work (searching) based upon an invitation from a sponsor (which may or may not also be a human searcher). In addition, a human searcher may allocate none, some, or all of his or her compensation to the sponsor and/or to one or more other individuals, for-profit entities, or not-for-profit entities.

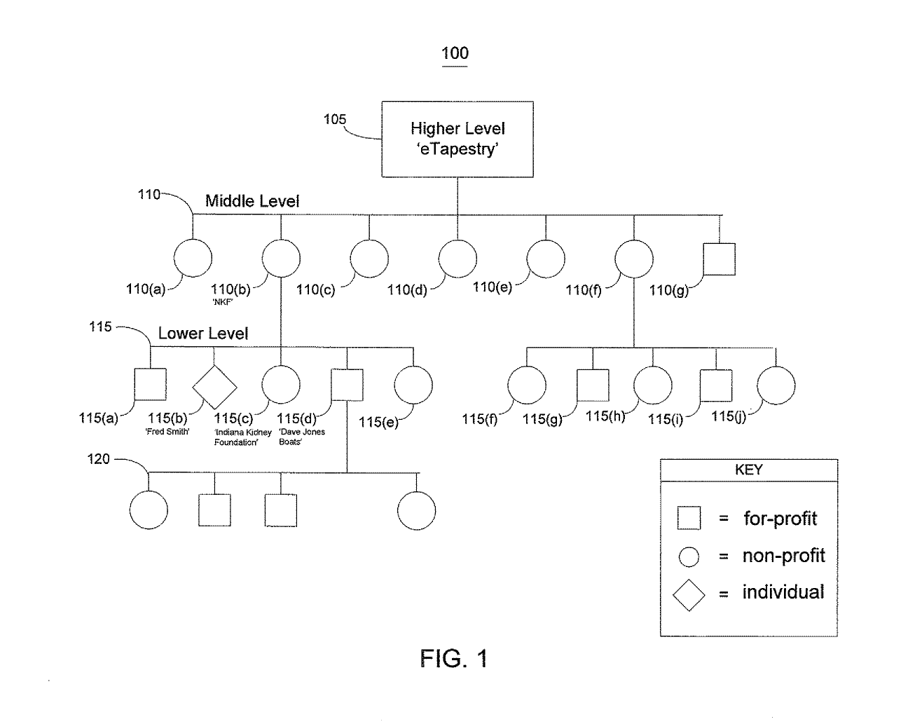

As has been described above, the multi-level system may be embodied as any of a large number of permutations of possible embodiments. For example purposes, one embodiment may involve a system as illustrated in FIG. 1. In FIG. 1, the multi-level marketing system 100 includes multiple levels including a “higher level” 105, a “middle level” 110, and a “lower level” 115 (other levels such as level 120 may be included in the system and it should be understood that there is an arbitrary number of levels in the system, limited only by the top of the structure which is intrinsically the highest level, there may be an arbitrary number of levels above the higher level 105 shown in FIG. 1. Theoretically, there is no limit to how many levels there may be below the lower level 115. The method of multi-level marketing may include utilizing individuals, non-profit entities, and for-profit entities. For each work task completed at a given level, the system may reward an entity at that level as well as an entity or entities “above” that level. Compensation for work performed at the lower level 115 may be partitioned to pay an entity at the higher level 105 (e.g., 1% commission), an entity at the middle level 110 (e.g., 10% commission), and at least one entity at the lower level 115 (e.g., $10 per hour) including at each level the possibility of participation from non-profit entities, individuals, and/or for-profit entities. Further, compensation could be allocated to levels above the higher level 105 shown in FIG. 1. As illustrated in FIG. 1, the higher level 105 includes at least one for-profit entity (but in other embodiments the top level entity could be a non-profit entity or an individual). As an example, a private, for-profit entity such as eTapestry® or Blackbaud® (both of which market their fundraising support products to charitable organizations), can be represented in the higher level 105. eTapestry® is a web-based donor database and communications management system that rents its software to customers who access it over the Internet. eTapestry® serves thousands of nonprofit organizations of all types and sizes that do not pay large upfront purchasing costs or engage in ongoing maintenance and support contracts typically paid in the purchase of more traditional non-profit management software. For-profit oriented organizations such as eTapestry® may include external fundraising software capabilities and/or infrastructure for charitable organizations that outsource some or all of their donor and/or fundraiser tracking so that the charitable organizations can better focus on effectively fulfilling their underlying charitable purpose. Third party organizations such as eTapestry® maintain databases and lists of prospective donors and contact information regarding the donors including e-mail addresses, mailing addresses and telephone numbers. As an example, eTapestry® may maintain a web presence including a webpage for the customer charitable organization. A person accessing a webpage served by eTapestry® on behalf of a charitable organization can arrange to donate money and/or other valuables to said charitable organization. These fundraising support organizations such as eTapestry® may also maintain special relationships with charitable foundations and other philanthropic organizations and individuals that donate funds to other charitable organizations. Due to their expertise in fundraising activities, such for-profit support organizations may retain a percentage of the donations which they solicit from donors on behalf of the charitable organization. Alternatively, they may charge outright for their products and/or services. Many of these for-profit fundraising organizations, such as eTapestry® provide web-based fundraising software, which software may be configured to include links for individuals or entities to register as a member of a multi-level marketing system to benefit a customer charitable organization (and to benefit the for-profit fundraising organization).

The middle level 110 (FIG. 1) includes at least one individual, non-profit entity or for-profit entity. For example a non-profit entity 110(a) such as one organized according to the laws of Title 26 Section 501(c)(3) of the United States Code (a “501(c)(3) organization”) could exist at the middle level as a non-profit entity 110(a)-110(f). In particular, such an entity may be the American Cancer Society, for example. Similarly, other non-profit entities may exist at the middle level 110 such as non-profit entity (e.g., 110(b)) relating to the study of kidney disease (e.g., the National Kidney Foundation (NKF)), the non-profit entity 110(c) relating to the study of breast cancer, and the non-profit entities 110(d)-110(f) and the for-profit entity 110(g) relating to various other health issues, for example. Each non-profit entity and/or for-profit entity at the middle level 110 can contribute a portion of its compensation to its sponsor, that is, to the for-profit entity at the higher level 105.

The system 100 also includes at least one income producing level such as the lower levels 115, 120. The lower levels 115, 120 may include a mixture of individuals, non-profit entities and for-profit entities. For example, the lower level 115 can include for-profit entities such as 115(a), 115(d), 115(g), and 115(i), non-profit entities such as 115(c), 115(e), 115(f), 115(h), and 115(j) and individuals such as 115(b).

It should be clear from this explanation that any level (e.g., 105, 110, 115, 120) of the system 100 may be comprised of zero, one, or multiple individuals, and/or zero, one, or multiple non-profit entities, and/or zero, one, or multiple for-profit entities but must contain at least one individual or entity.

The system 100 may allocate compensation to a non-profit entity (i.e., a sponsor) at the middle level 110 in an amount proportional (e.g., 10%) to the compensation of an entity at a lower level 115 (i.e., an associated sponsoree). Any of the entities at the lower level 115 can choose and indicate if it wishes to donate a percentage of his or her earnings or a fixed portion of his or her earnings to a designated sponsor at a the higher level 110.

For example, an individual(s) (e.g., a Girl Scout troop) in the lower level 115 might be sponsored by the Girl Scouts of the United States of America (GSA). The GSA regional office might be at the middle level 110, and the GSA national office might be at the higher level 105. In this example, troop members might perform a search task(s) (e.g., locating information related to scouting). The troop members might earn $5.00/hour for performing searches, the regional office might receive 10% of the earnings by a troop(s) within their region, and the national office might receive 1% of the earnings by all troops nationwide. In this example the network is homogenously not-for-profit.

After being presented with the disclosure herein, one of ordinary skill in the relevant art would readily appreciate that the embodiments described herein can be employed in a variety of different environments. For example the method can be employed in an electronic network environment. In such an embodiment, the method can be employed via the Internet utilizing the World Wide Web.

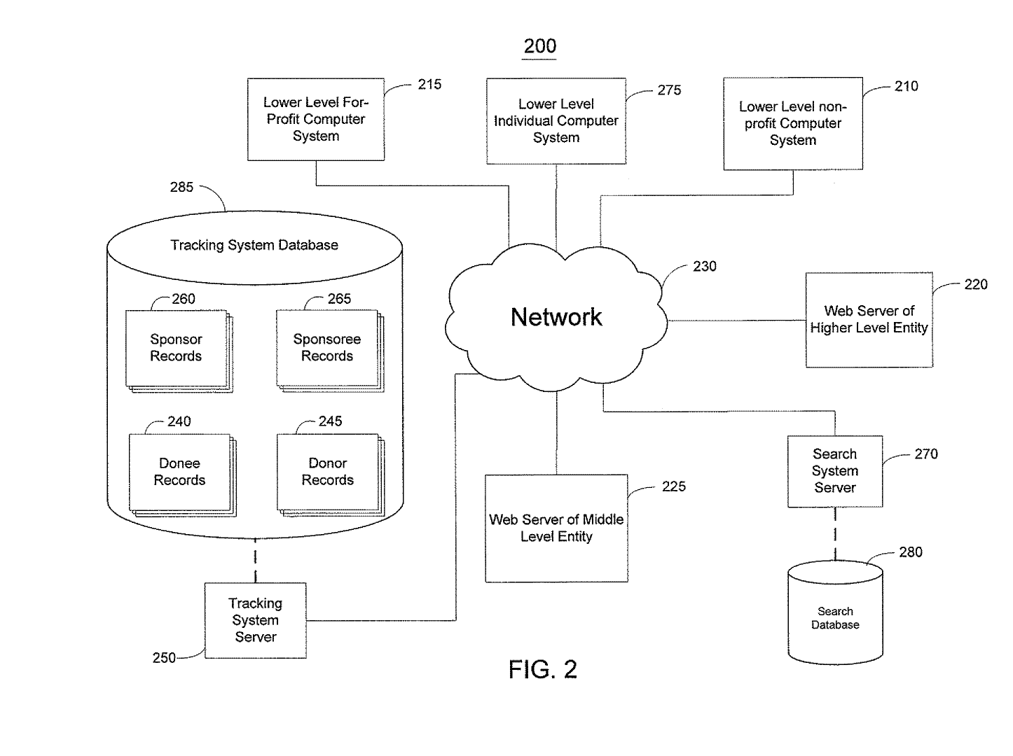

As illustrated in FIG. 2, an online multi-level marketing system 200 is provided. The system 200 can include a web server 220 of a higher-level for-profit entity 105 (FIG. 1), for example, eTapestry®. The tracking system server 250, which could be a component of the search system 270, for example a search system as described in U.S. application Ser. No. 11/336,928, entitled, “A Scalable Search System Using Human Searchers”, by Scott A. Jones, filed Jan. 23, 2006 incorporated herein by reference, which will be noted later herein and assigned to ChaCha® Search, Inc., is resident in or communicatively coupled via network 230 to donee records 240, donor records 245, sponsor records 260 and sponsoree records 265. The donee records 240, donor records 245, sponsor records 260 and sponsoree records 265 may store data utilized in providing functionality to the system, as will be described herein in further detail below. It should be realized that these records could also be resident in other components of the system such as the higher level for-profit entity web server 220.

The system can include a web server 225 of a middle level non-profit entity, such as, 110(b) (FIG. 1), for example, the National Kidney Foundation. In addition to the web servers identified above, the system 200 can include computer system(s) operated by a lower level entity(ies), such as the lower level for-profit computer system 215 operated by a lower level for-profit entity, such as 115(a) (FIG. 1). A lower level non-profit computer system(s) 210 such as one operated by the lower level non-profit entity 115(c) may also be included in the system 200, as can lower level individual computer system(s) 275 operated by lower level individuals, such as the lower level individual 115(b) (FIG. 1). The search system 270 may comprise a search database 280 which may include information relevant to performing search related tasks.

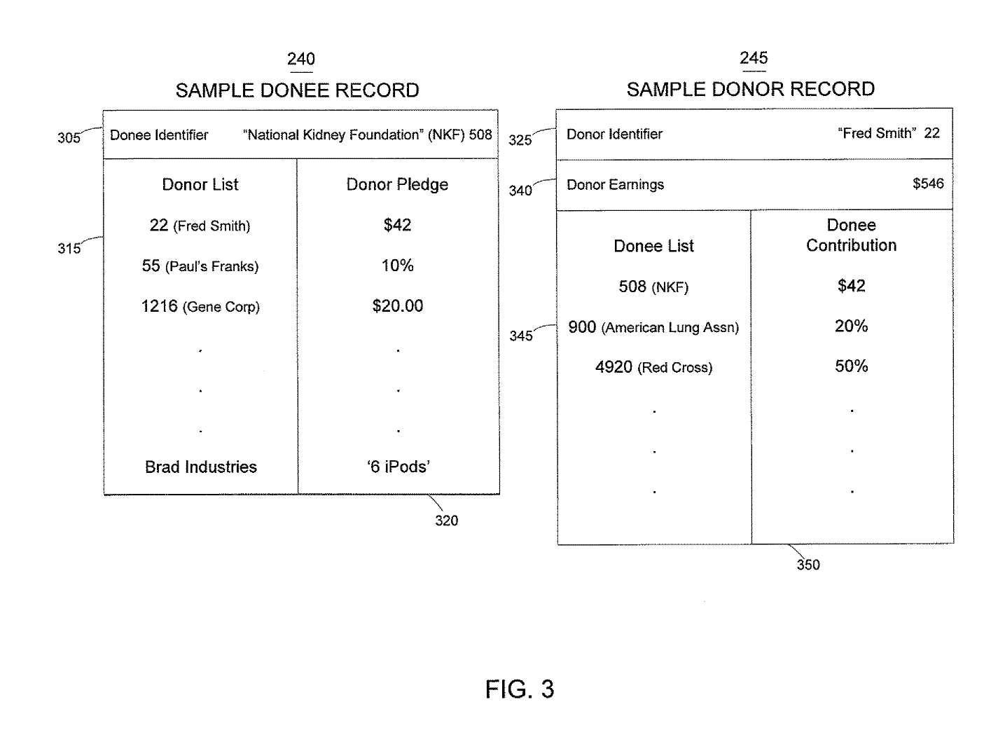

As illustrated in FIG. 3, the donee record 240 includes donee identifier field 305, donor list field(s) 315 and a donor pledge field(s) 320. The donor record 245 includes a donor identifier field 325, a donor earnings field 340, a donee list field(s) 345 and a donee contribution field(s) 350.

The donee record 240 includes a donee identifier field 305 for identifying the recipient of funding, for example, the “National Kidney Foundation” (NKF). The National Kidney Foundation might be for example, the middle level entity 110(b) (FIG. 1). The National Kidney Foundation may have sponsored an individual, such as the lower level individual 115(b), for example, “Fred Smith” who becomes a donor. The system may pay a commission of 10% of the earnings of the lower level individual 115(b) to the National Kidney Foundation. While only one donee record 240 is illustrated in FIG. 3, it is envisioned that a separate donee record 240 may be maintained by the tracking system server 250 (FIG. 2) for each middle level entity 110 or any entity within the system which is a donee. In such a scenario, the donee identifier field 305 may serve to distinguish the donee record 240 associated with a donee from the donee records 240 associated with other donees. The donee identifier field 305 includes an identifier of a donee which uniquely identifies the donee and may include a randomly generated number.

The donor list field(s) 315 includes a donor identifier for identifying donors to a donee, for example, an individual who accessed the website of the National Kidney Foundation and signed-up to become a member of the lower level 115 of the multi-level system, thereby becoming a donor of the organization.

In at least one embodiment, the donor list field(s) 315 and donor pledge field(s) 320 are linked, via a pointer, for example. Each entry in the donor list field 315 corresponds to an entry in the donor pledge field 320.

The donor pledge field(s) 320 includes an indicator of contribution(s) by a donor associated with the donor ID included in the donor list field(s) 315. The donor pledge field(s) 320 includes an indication of a pledge amount by the donor (for example ‘$42’, ‘10%’, or ‘6 iPods’). For example, an individual “Fred Smith” may pledge forty-two dollars to the National Kidney Foundation. In such an instance, the donor pledge field(s) 320 in the donee record 240 of the National Kidney Foundation corresponding to the donor record 245 of a person and/or entity for example, Fred Smith (donor ID number “22”) would specify forty-two dollars. A donor associated with a donor record 245 associated with the donor ID in the donor list field(s) 315 may accrue earnings which are credited to donees and tracked in the donor pledge field(s) 320 according to information in the donor record 245.

As shown, for example, in FIG. 3, the donor record 245 includes a donor identifier field 325, a donor earnings field 340, a donee list field(s) 345, and a donee contribution field(s) 350. A donor may be an individual, for-profit or non-profit entity and may be a sponsored worker or entity within the system. Thus, donor records envision that the system 200 (FIG. 1) will permit donations to be made to donees both from individuals who are and who are not members of the system 200.

Donor identifier (ID) field 325 (FIG. 3) includes a text string identifying a unique “name” of the donor. The donor UID field 325 includes a numerical identifier of the donor to which the donor record relates and may include a random number. The data in the donor identifier field 325 serve to distinguish the donor record 245 associated with a particular donor from the donor records 245 associated with other donors in the system 100.

Donor earnings field 340 includes data indicating the available earnings of a donor such as when a donor is a paid worker member of the system 200 (FIG. 2). When a donor does not generate income from the system, the donor earnings field 340 may be blank.

The donee list field(s) 345 includes entries for donees to whom the donor has elected to contribute. The donee contribution 350 contains information indicating a percentage of earnings, dollar amount, good, service, etc. which may be donated to the donee associated with the corresponding donee ID in the donee list field(s) 345.

In the embodiment illustrated in FIG. 3, since the donor ‘Fred Smith’ associated with the donor record 245 has earnings from the system (shown in the donor earnings field 340) some of the entries in the donee contribution field(s) 350 are percentage amounts of earnings to be contributed to a donee. However, it is within the scope of the disclosure for the entries in the donee contribution field(s) to be dollar amounts, goods, services, etc. rather than a percentage of total earnings, as illustrated in FIG. 3 (e.g., ‘$42’). The donee contribution field(s) 350 might also contain information to prioritize contributions to donees. For example a donor might elect to contribute the first $42 of earnings to the National Kidney Foundation and the next $20 of earnings to the American Cancer Society and distribute any additional earnings equally between both donees.

After being presented with the disclosure herein, one of ordinary skill in the relevant art will readily realize that other fields may be present in the donor and/or donee record. For example, in at least one embodiment, a donor record 245 can include a donor profit status field, which specifies whether a donor is a for-profit entity or a non-profit entity. Likewise, a donee record 240 may include similar or other information.

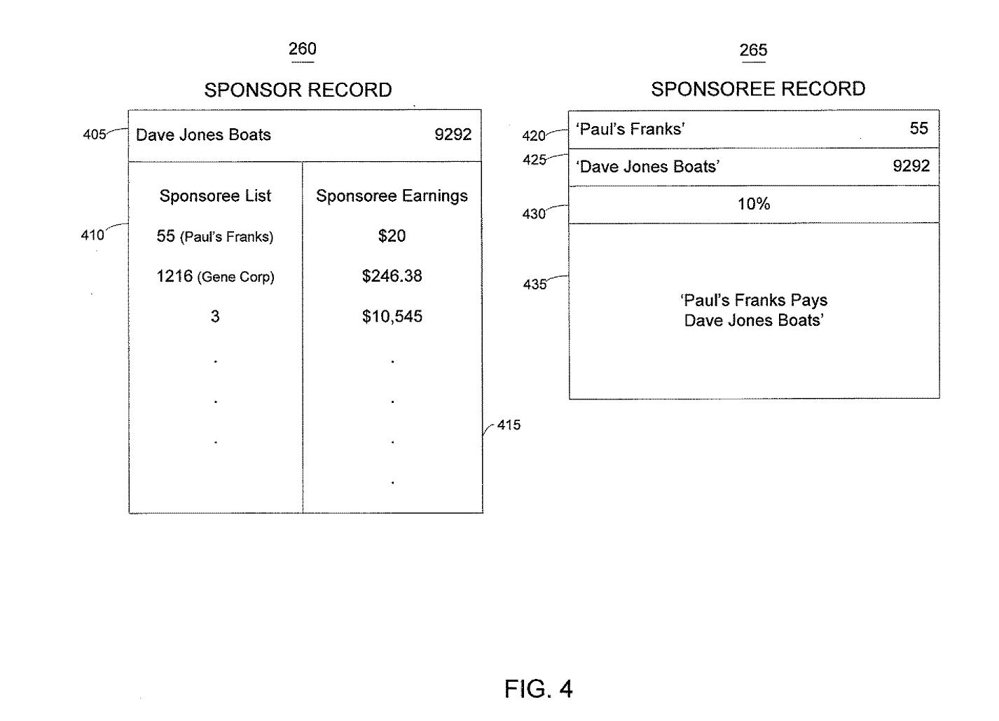

As illustrated in FIG. 4, in at least one embodiment, the system 200 (FIG. 2) maintains a sponsor record 260 for each sponsoring entity in the system and a sponsoree record 265 for each sponsored entity in the system.

In one embodiment, sponsor record 260 includes a sponsor ID field 405, a sponsoree list field 410 and a sponsoree earnings field 415.

The sponsoree record 265 includes a sponsoree ID field 420, a sponsor ID field 425, a mandated commission to sponsor field 430, and a commission paid by field 435. The sponsoree record 265 may contain a sponsor list field, an elective sponsor contribution field a sponsoree for-profit status field, a required system mandated contribution field, or other fields. While shown as separate records, it is within the scope of this disclosure for the sponsor record 260 and donee record 240 (FIG. 3) to be maintained as a single record and for sponsoree record 265 (FIG. 4) and donor record 245 (FIG. 3) to be maintained as a single record.

The sponsor ID field 405 (FIG. 4) includes a text string identifying a member of the system who has sponsored another entity and serves to distinguish the sponsor record 260 of one individual sponsoring entity from the sponsor record 260 of other sponsoring entities in the system. The sponsor ID field may include a numeric identifier of the sponsor which may be based on a random number.

The sponsoree list field 410 contains one or more entries including data identifying entities sponsored by the sponsoring entity. The sponsoree earnings field 415 contains one or more entries including data indicative of the earnings of each entity sponsored by the sponsor with which the sponsor record 260 is associated. Each entry in the sponsoree list field 410 is linked to the appropriate associated entry in the sponsoree earnings field 415.

The illustrated sponsoree record 265 includes a sponsoree ID field 420 including a text string indicative of the sponsoree's name which data serves to distinguish one sponsoree record 265 from another. The sponsor ID field 425 includes information, such as numerical data, identifying the sponsor.

In at least one embodiment, a sponsoree is required to pledge or contribute a portion of earnings from the system to a sponsor, this required contribution amount may be stored in the mandated commission to sponsor field 430 (FIG. 4). The sponsoree may elect to contribute additional earnings to the sponsor or to other sponsors/donees registered with the system. The additional elected contribution, in the illustrated embodiment, is maintained in a separate donor record 245 (FIG. 3) associated with the sponsoree.

In the illustrated embodiment, a commission paid by field 435 (FIG. 4) includes information indicating whether commission is paid by the system or by the sponsoree. In one embodiment, the system maintains the records and pays commissions on behalf of sponsorees. In other embodiments, one or all sponsorees may be required to pay commissions to their sponsors.

As explained above, the commission to sponsor field 430 includes a monetary amount that a particular sponsoree may be required to pledge to his or her sponsor. For example, in at least one embodiment, a sponsoree may be required to pledge ten percent of his or her earnings to his or her sponsor.

It should be noted that a sponsoree is not required to make additional contributions to his or her sponsor. For example, the sponsoree may elect to contribute zero percent of his or her earnings. However, in the illustrated embodiment, if a sponsoree elects to make an additional contribution to his or her sponsor, such contribution would be reflected in the donor record 245 (FIG. 3) associated with the sponsoree.

While only one exemplary sponsoree record 265 is illustrated in FIG. 4, it is envisioned that a separate sponsoree record 265 may be maintained for each sponsoree in the system. For example, the higher level for-profit entity 105 (FIG. 1) might maintain a sponsoree record for each sponsoree at the middle level 110 and the lower level(s) 115, 120. In such a scenario, the sponsoree ID field 420 (FIG. 4) serves to distinguish the sponsoree record 265 associated with a sponsoree from the sponsoree records 265 associated with other sponsorees.

The sponsoree record 265 may include additional fields and information within the scope of the disclosure. For example, a sponsoree profit status field may indicate a profit status for a particular sponsoree. For example, if a sponsoree voluntarily elected to contribute only a portion of his or her earnings, in addition to the requisite portion, the sponsoree would be considered a for-profit sponsoree, as he or she earns a profit for his or her work. Alternatively, if the sponsoree elected to contribute all of his or her earnings, the sponsoree could be considered a non-profit sponsoree, as he or she does not earn a profit for his or her work.

As previously described, sponsor ID field 425 (FIG. 4) identifies the sponsor of the sponsoree and can contain encrypted information associated with the contents of a sponsor record 260.

In one embodiment of the disclosed multi-level marketing system, in order for an organization or an individual to become a participating member of the multi-level marketing system, the prospective member must be sponsored or invited to become a member of the multi-level marketing system by a current member of the multi-level marketing system. In one embodiment of the multi-level marketing system, members of the system may be computer task workers who perform tasks for compensation. Such tasks may include performing searches on behalf information seekers submitting queries to a search system provider, answering poll questions, reviewing images for tagging, transcribing recordings, training searchers, reviewing search result(s), providing training materials, etc. An example of a search system utilizing human searchers or guides registered with the system to assist information seekers in receiving search results in response to a query is disclosed in U.S. application Ser. No. 11/336,928, previously mentioned and incorporated herein by reference.

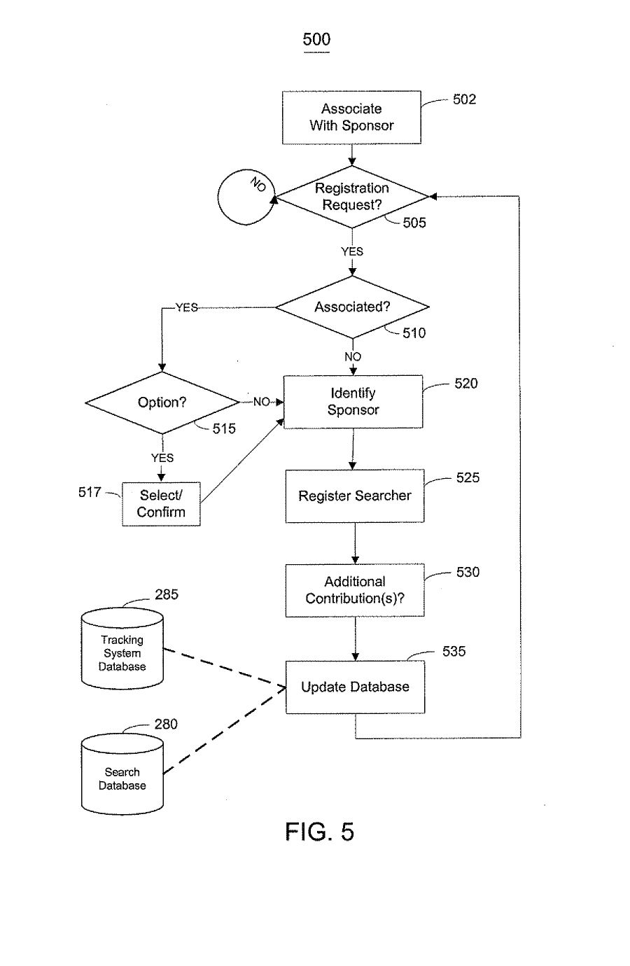

As illustrated in FIG. 5, method 500 for recruiting human searchers in an information search system is provided in at least one embodiment. In one such system a human searcher must be registered with the search system provider in order to receive queries and compensation for aiding an information seeker in obtaining a result responsive to a query submitted to the search system.

In operation 502, a worker, such as a human searcher is associated with a sponsor of the worker. In at least one embodiment, the associating includes presenting an option using an interactive information product.

For example, a membership Web page describing the sponsor allows a human searcher to be associated with the sponsor when conducting searches. The webpage may automatically associate the human searcher with the sponsor when an option is selected by the human searcher. In at least one embodiment, a membership and/or registration page includes an option to donate any portion of the compensation of the human searcher to the sponsor when the sponsor is a non-profit organization.

Alternately, a registered human searcher or guide might create a Weblog (blog) accessible by anyone having Internet access. Visitors to the registered guide's blog may include other registered guides and individuals who are not yet registered guides. The registered guide who created the blog may include a hyperlink on the blog page that directs visitors interested in becoming registered guides with the search system to a registration page on a webpage of the search system. Such a hyperlink may be created by the registered guide or may be made available for download and incorporated into the registered guide's blog page by the search service provider. For example, in at least one embodiment, as a visitor to a blog desiring to become a registered guide accesses a membership registration webpage of the search service provider via a hyperlink on a blog.

A sponsor identification code associated with the registered guide who created the blog or a number identifying the registered guide who created the blog as the sponsor of the visitor is automatically associated with the new entity. The received sponsor identifier number allows the new entity to be associated with its sponsor, that is, the author of the blog in the above-identified example.

Therefore, upon completing an electronic membership registration page on the website of the search system provider, the visitor to the blog or the guide directed from the non-profit webpage does not have to provide the sponsorship information. The new registrant's sponsor is automatically determined, (e.g., the author of the blog or the non-profit organization who might be in the middle level 110 (FIG. 1)). That is, a human searcher can be associated with an identifier of the sponsor, thereby associating the sponsor with the recruited human searcher and/or entity.

After being presented with the disclosure herein, one of ordinary skill in the relevant art will readily appreciate that other methods of associating a sponsor with a new entity may be employed without departing from the spirit and scope of the embodiments described herein. For example, in at least one embodiment, the sponsor number is provided via correspondence such as a letter, business card, e-mail, instant message session, chat session, etc.

In operation 505 (FIG. 5) a determination is made whether a registration request has been received. If a request is not received, method 500 continues to wait for a registration request. If a registration request is received, control is passed to operation 510 and method 500 continues.

In operation 510 (FIG. 5) a determination is made whether a registrant has been automatically associated with a sponsor. If it is determined that a registrant has been automatically associated with a sponsor, a registrant may be notified of the sponsoring relationship and control is passed to operation 515. If it is determined that a registrant has not been automatically associated with a sponsor, control is passed to operation 520 and method 500 continues.

In operation 515 a determination is made whether a registrant may modify the associated sponsor. The option to modify the associated sponsor may be offered to ensure that the sponsoree and/or sponsor has consented. This may prevent a link which appears to offer sponsorship by a charity, but actually designates an individual as a sponsor without informing the sponsoree from being used. If in operation 515 it is determined that the registrant may not modify the sponsor, control is passed to operation 520 and method 500 continues. If in operation 515 it is determined that a sponsoree may modify the sponsor, control is passed to operation 517 and method 500 continues.

In operation 517 the sponsoree is allowed to select or confirm his or her sponsorship, control is passed to operation 520 and method 500 continues. The selection or confirmation of a sponsor may include a notification to the original sponsor of the change of election.

In operation 520 a sponsor of the registrant is determined. Mandatory system contribution based on the sponsorship may also be determined. Control is passed to operation 525 and method 500 continues. In a preferred embodiment, the sponsorship selection is fixed by the association in operation 502.

In operation 525 a registration process for the search system is performed. The human searcher registers with the search system, and is associated with a sponsor via a sponsoree record and sponsor record as described herein. Control is passed to operation 530 and method 500 continues.

In operation 530 a sponsoree that has completed the registration process may be offered an option to contribute additional compensation to a sponsor and/or other donees registered with the system 200 (FIG. 2). Control is passed to operation 535 (FIG. 5) and method 500 continues.

In operation 535 the search database 280 (FIG. 2) and the tracking system database 285 are updated, control is passed to operation 505 and method 500 continues.

As previously described, in at least one embodiment, a human searcher earns compensation that may be based on a number of searches performed, a number of other tasks performed, amount of time spent searching, etc. However, a sponsored entity may elect to allocate a percentage (00-100%) of its compensation to its sponsor. In other words, although a new entity (e.g., the visitor to the blog in the example above) may generate compensation for its sponsor, the entity can determine whether it wishes to donate additional earnings to the entity's sponsor and/or to one or more other donees. In the preferred embodiment, the compensation of a sponsor is based on the compensation of a sponsoree, but the commission costs are funded by the search system. An alternative embodiment could require a sponsoree to pay its sponsor directly out of the funds earned by the sponsoree.

It should be noted that in at least one embodiment, the sharing of compensation includes determining recruitment compensation for a sponsor based on the multi-level marketing structure described in the text accompanying FIG. 1.

For example, in at least one embodiment, an entity of the middle level 110 as a sponsor of recruit(s) is provided with a bonus based upon the percentage of total earnings produced for an entity at the higher level 105 by recruit(s) of the entity of the middle level 110. In continuing with the example above, after the visitor to the blog is directed to the membership application page on the website of the search system provider, the visitor is prompted to designate a percentage (0%-100%) of his or her earnings to be contributed to his or her sponsor, that is, to the blogger.

It is understood that a sponsor might be an individual, a for-profit entity such as Delta® Air Lines, or a non-profit entity such as the American Cancer Society. Further, it is possible that the visitor (the sponsoree) may subdivide its voluntary allocation among one or more donee(s) which may or may not include the sponsor.

For example, the for-profit entity 115(a), a contributor to the non-profit entity 110(b) ‘NKF’ may elect not to voluntarily contribute any of its earnings to its sponsor, that is, to the non-profit entity 110(b). However, in the preferred embodiment, an amount equal to 10% of the earnings of the for-profit entity 115(a) is allocated to the sponsor (i.e., 110(b)) by the system and paid for by the system rather than by the sponsoree directly. In such an instance, the for-profit entity 115(a) earns compensation for itself while assisting with the cause of its sponsor, which is to raise money for research relating to kidney disease, for example. The non-profit entity 115(c) could operate in a similar manner, keeping earnings for itself while still allowing the sponsor (i.e., entity 110(b)) to benefit from the sponsor commission of 10% provided by the system in the preferred embodiment.

In contrast, the individual 115(b) ‘Fred Smith’, a sponsoree of the non-profit entity 110(b) (e.g., ‘National Kidney Foundation’) may elect to contribute all of his or her earnings to its sponsor, that is, to the non-profit entity 110(b) in addition to the system's allocation to the sponsor of ten percent of the earnings of the sponsoree, for example. The 10% of earnings compensation provided by the system plus the allocation of earnings by the sponsoree provide maximum benefit to the charity (e.g., the National Kidney Foundation). The system paying for the work can access the records previously discussed and allocate 10% of the earnings by the sponsoree to the sponsor as a commission and 100% of the earnings for the work to the sponsor.

If the situation is that of a mandatory donation of a percentage of the funds earned by the sponsoree and the system does not pay the commission then the system would allocate 10% of the compensation of a sponsoree 115(c) ‘Indiana Kidney Foundation’ to the sponsor 110(b) and 90% to the sponsoree 115(c).

It should be noted that entities that are lower in the tree after subsequent sponsoring of additional entities into the system may elect to modify the allocation of their earnings to a sponsor and/or donee.

Therefore, it can be seen that there is a very flexible incentive structure using this system that provides incentives for involving numerous entities who may or may not choose to allocate their own earnings to the sponsoring entity.

In the case of a non-profit entity, such as the entity 110 (f), for example a school, the system can accommodate parents, friends, families, organizations, companies, etc. associated with the school to be sponsored by the school in the lower level 115 in a flexible manner that allows some individuals or entities to operate for their own benefit, earning compensation for themselves, or to operate for the benefit of the school by donating additional earnings to the school. In both cases the school benefits from the system's allocation of 10% of the earnings of the entity, regardless of the elections of sponsorees at the lower level 115. This mechanism may provide a very flexible and valuable system for raising money for the beneficiary. (e.g., the school).

As a result of the system and method described above, a marketing operation can be conducted in which each entity of a particular level is sponsored by an entity of a higher level. As a result of the mixture of individuals, for-profit entities, and/or non-profit entities, a more global marketing approach can be experienced, thereby resulting in the potential for increased profits to the profit-earning entities.

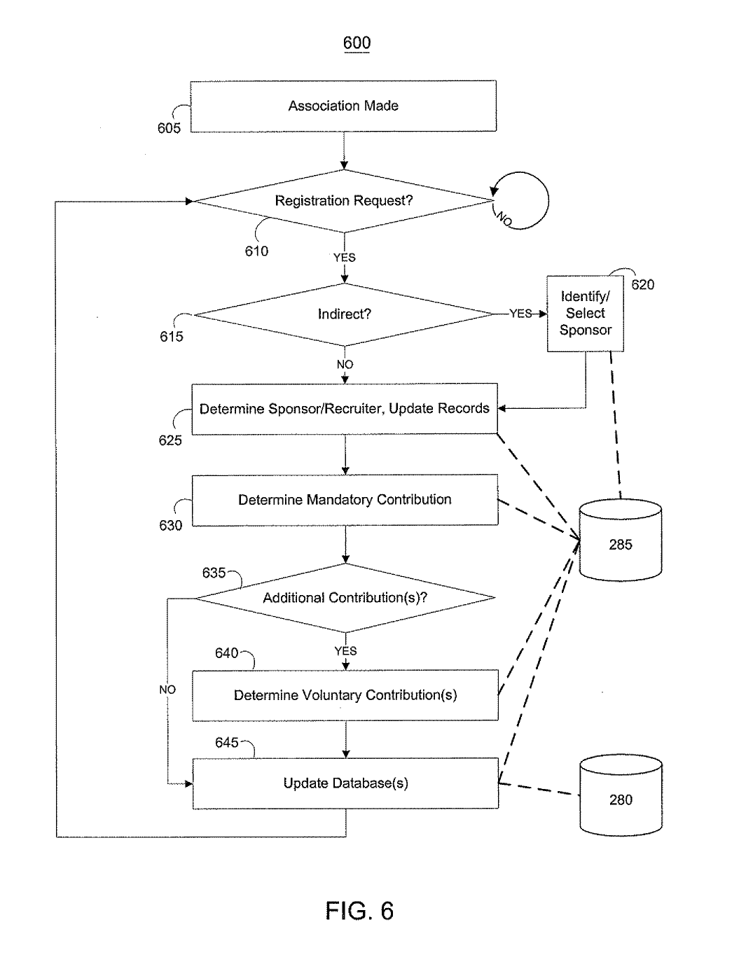

As illustrated in FIG. 6, an alternate method 600 for sponsorship in a multi-level marketing system is provided in at least one embodiment.

In operation 605, an entity seeking to be sponsored to register with the search system accesses a web server or other interface and is associated with a sponsor.

For example, the higher level for-profit entity web server 220 (FIG. 2) is accessed via a website of the entity at the higher level 105 (e.g., eTapestry®) or the web server of a middle level entity 225 operated by an entity at the middle level 110, such as entity 110(b) (e.g., the National Kidney Foundation) is accessed by an entity which will be sponsored at the lower level 115, An individual associated with entity 115(a) operating the lower level for-profit computer system 215 (FIG. 2) may enter a URI into his or her computer system's browser to access the higher level entity web server 220. From this website the individual may activate a hyperlink to obtain access to a registration website of the search system server 270, where the individual may sign-up to be a worker or human searcher for a system such as that previously described herein. The link from the higher level entity website may specify that the higher level entity 105 (FIG. 1) is the sponsor for the lower level entity 115(a). Alternately there may be a database where many charities are listed (the customers of eTapestry®, for example) which may include, for example, the National Kidney Foundation, which could be used to designate the National Kidney Foundation as the sponsor of the lower level entity 115(a) even though the accessed website was that of the higher level entity 105 (e.g., eTapestry®).

A second individual (e.g., 115(b) (FIG. 1)) operating the lower level individual computer system 275 (FIG. 2) may enter into a browser a web address of an entity at the middle level 110 for example the entity 110(b) ‘National Kidney Foundation’ to access the organization's website via the web server of the middle level entity 225 (FIG. 2). From the organization's website, the individual (e.g., 115(b)) may activate a hyperlink to obtain access to a website of the search system server 270, where the individual may sign-up to be a worker or human searcher for the system. The individual would be identified as being sponsored by the middle level entity 110(b) (e.g., ‘National Kidney Foundation’).

In operation 610 (FIG. 6) a determination is made whether a registration request is received by the search system server 270 (FIG. 2). If a registration request is received, control is passed to operation 615 and method 600 continues. If a registration request is not received, method 600 continues to wait for a registration request.

In operation 615, a determination is made as to whether the lower level member accessed the higher level entity web server 220. If it is determined that the lower level member, for example, individual 115(b) above, did not access the higher level entity server 220, control is passed to operation 625 and method 600 continues. If in operation 615 it is determined that the lower level member, for example, the entity 115(a) identified above, accessed the higher level entity web server 220, control is passed to operation 620 and method 600 continues.

In operation 620, the sponsor of the lower level member is determined based on the information provided from the registration request sent from the higher level entity web server. The tracking system database is updated to reflect this indirect sponsorship. Control is passed to operation 625 and method 600 continues.

Alternately, a sponsor may be selected by the sponsoree during the registration process. In other words, when a lower level member (for example, an individual who may want to act as a donor to a charitable organization) accesses the higher level entity web server 220 (FIG. 2) (for example, an eTapestry® server) the lower level member is identified as being recruited by the higher level entity, but is provided with a choice as to which entity he or she wishes to be his or her sponsor.

In operation 625 (FIG. 6), a sponsor, is determined by the system for the lower level member and added to the sponsor and sponsoree records 260, 265 previously discussed. In continuing with the examples provided above, if the member accessed eTapestry®'s website, a sponsoree identifier, for example, the member's name, is added to the sponsor record 260 (FIG. 4) of the sponsor determined, and a sponsoree record 265 is created. While the identifier received from the higher level entity web server 220 may designate the same sponsor (e.g., the National Kidney Foundation), the sponsor identifier contained in the registration request to the search system server 270 is not the same as the sponsor identifier in the registration request sent by the middle level entity web server 225 in operation 605. Control is passed to operation 630 and method 600 continues.

In operation 630 (FIG. 6), a required contribution for the sponsoree is determined. For example, in at least one embodiment, an individual sponsoree is required to contribute or pledge ten percent of the individual's earnings to the sponsor. In such an embodiment, a corporate sponsoree, such as entity 115(a) in the example above may be required to contribute thirty percent of the corporation's earnings for information search services provided by the organization to the sponsor. Control is passed to operation 635 and method 600 continues.

In operation 635, a determination is made as to whether a sponsoree elects to make an additional voluntary contribution of the sponsoree earnings to the sponsor or other donees. If it is determined that the sponsoree does not elect to contribute additional earnings to a sponsor or other donees, control is passed to operation 645 and method 600 continues. If it is determined that a sponsoree elects to contribute additional earnings to a sponsor or other donees, control is passed to operation 640 and method 600 continues.

For example, an altruistic individual donor may wish to contribute one hundred percent of his or her earnings to his or her sponsor or other donees. In contrast, a for-profit corporation or an individual searcher may not wish to contribute any additional amount to the sponsor (which is a donee already by virtue of the 10% commission).

In operation 640 any additional contributions by a sponsoree are determined, sponsor/donee records 240, 260 and sponsoree/donor records 245, 265 are updated, control passes to operation 645 and method 600 continues.

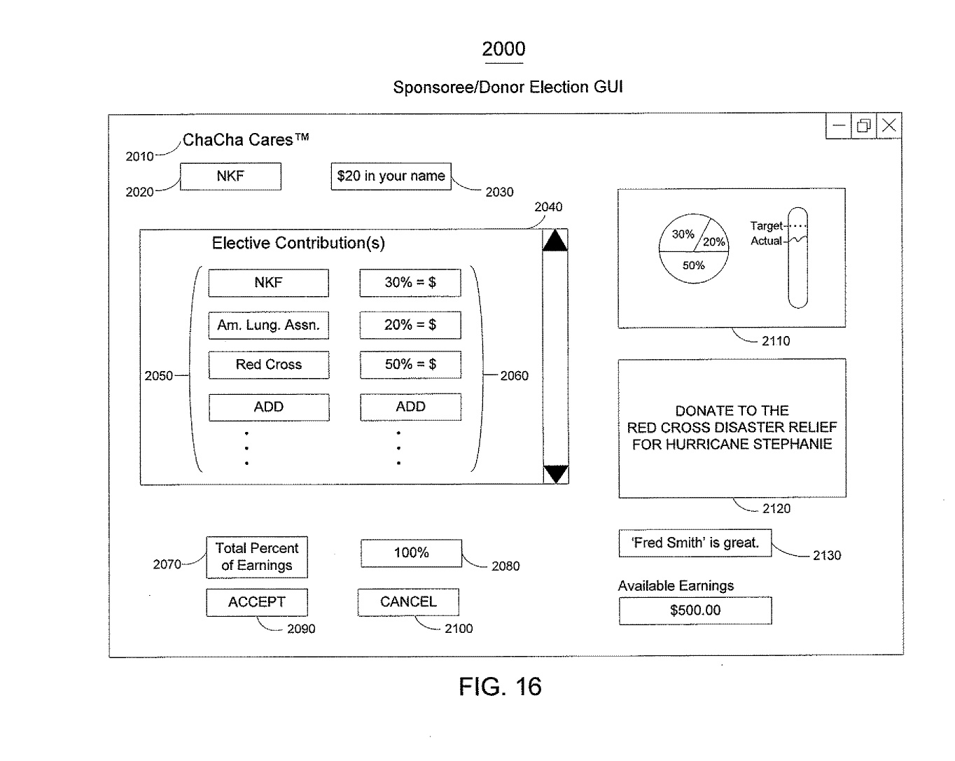

In at least one embodiment the sponsoree is presented with a graphical user interface (GUI) such as the GUI depicted in FIG. 16 prompting the donor for his or her choices regarding additional elective contributions. The sponsoree may elect to pledge or contribute earnings to one or more entities.

In operation 645, the databases 280, 285 (FIG. 2) are updated, control is passed to operation 610 and method 600 continues.

Using the method 600, the system 200 (FIG. 2) is able to differentiate entities which may have been indirectly recruited from entities that are directly recruited by the sponsoring entity. In this way, compensation may be allocated to the entity or individual that recruited an entity or individual while allowing the recruited entity to select a sponsor who may not have recruited the entity. This may provide an incentive for an organization or individual to recruit guides and/or affiliated organizations for the search system who may contribute earnings to another entity. As in the example above, eTapestry® might receive a per searcher dollar amount (e.g., $10) or a percentage of earnings (e.g., 1%) of searchers recruited for a non-profit organization while any or all of the earnings of the searcher are allocated to the non-profit organization by the system. Other methods of determining compensation for the recruiting entity may be utilized within the scope of this disclosure.

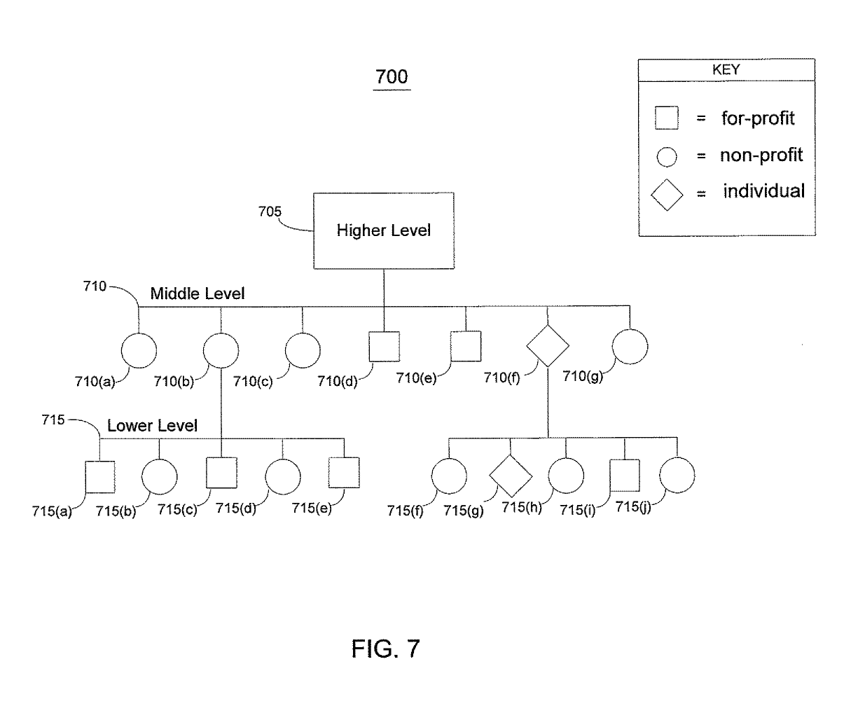

As will be described in conjunction with FIG. 7 the embodiments described herein can be employed in an information search system utilizing human searchers in at least one embodiment. As a result, the embodiments described herein can enhance the recruitment efforts of a provider of the embodiments by allowing multi-level recruiting and marketing to be experienced. As illustrated in FIG. 7, the marketing system 700, according to at least one embodiment, includes at least one higher level 705, a middle level 710, and lower level 715.

The higher level 705 may include the search system provider. For example, the provider of the embodiments described herein can be a private, for-profit corporate entity under a contractual relationship with multiple human searchers to answer queries of multiple information seekers.

The middle level 710 and the lower level 715 can both include human searchers or guides 710(a)-710(g) and 715(a)-715(j) that will be under a contractual relationship with the provider of the embodiments described herein to field or answer queries of information seekers.

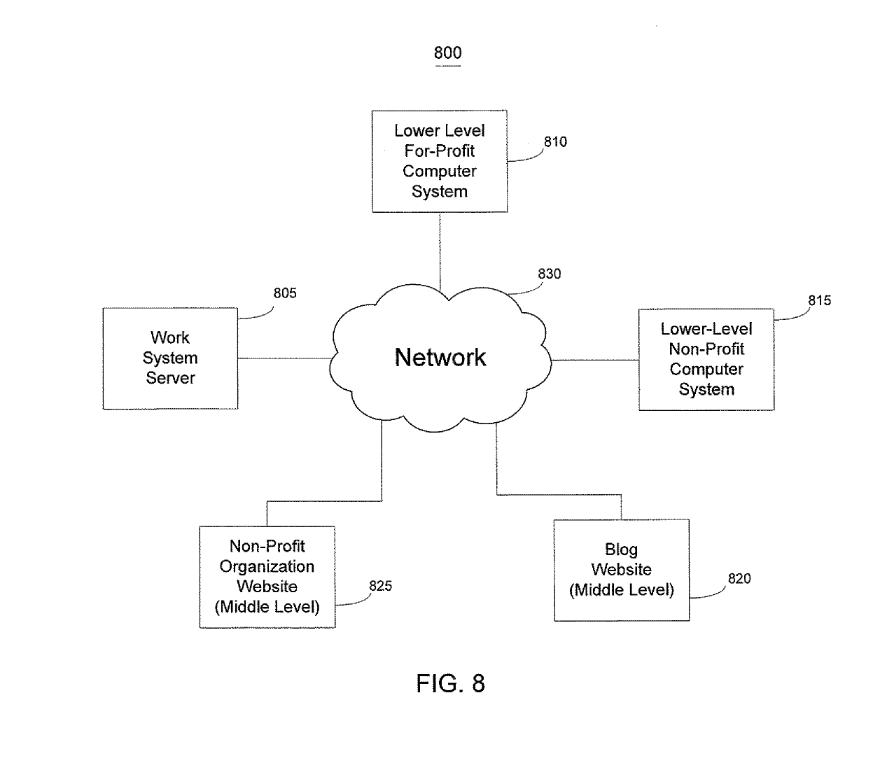

As illustrated in FIG. 8, system 800 is provided in at least one embodiment. The system 800 includes a work system server 805, such as a server-type computer or search computer system, a lower level for-profit computer system 810, a lower level non-profit computer system 815, a blog website 820 of a for-profit entity at the middle level 710 (e.g. 710(f) (FIG. 7)), and a website of a non-profit organization 825 at the middle level 710 (e.g., 710(b)). In at least one embodiment, at least one website interface is communicatively coupled to the search computer system to allow communication to occur between the search computer system of the work system server 805 and at least one other computer system or website such as the for-profit lower level computer system 810 and/or the blog website 820 via network 830.

The work system server 805 can include a search system providing information searching with human searchers, such as described in more detail in U.S. application Ser. No. 11/336,928 previously mentioned. The for-profit lower level computer system 810 can be a computer system, such as a desktop computer or any other computer system, operated by a for-profit lower level member (e.g., 715(g)), such as an individual desiring to earn a profit from providing his or her services as a human searcher registered with the work system server 805. In at least one embodiment, the for-profit lower level member does not pledge an additional amount over the required contribution to its sponsor.

In contrast, the non-profit lower level computer system 815 can be a computer system operated by a non-profit lower level member (e.g., 715(b)) such as a member desiring to assist a charity such as the National Kidney Foundation. For example, in at least one embodiment, the non-profit lower level member pledges one hundred percent of his or her earnings to its sponsor, as the member desires to work to assist his or her non-profit sponsor.

The website of a non-profit organization 825 (FIG. 8) can be a website hosted by a charitable organization such as the National Kidney Foundation or the National Cancer Institute, for example. In at least one embodiment, a member seeking to be sponsoree of a charitable organization accesses the website of the charitable organization, that is, the website of the non-profit organization 825. For example, the non-profit lower level computer system 815 may be operated by such a member. Upon accessing the website, the member can activate a hyperlink advertising search services employment with the search system provider. For instance, the hyperlink may be associated with an advertisement captioned, “Sign-up to be a human searcher to help the National Kidney Foundation”. Upon activating the hyperlink, the member may be directed to the website of the search system provider, which is associated with or can be hosted by the work system server 805, and conventionally presented with a membership application webpage to allow the member to “sign-up” to become a human searcher in the information search system.

As a result, the provider of the search system can potentially increase recruiting of human searchers to be employed in its information search system, and non-profit organizations, for example, charitable organizations, can increase support and income for their cause.

Similarly, the blog website 820 can be a personal diary website hosted by an individual searcher already employed in the information search system as a human searcher (e.g., 710(f) (FIG. 7)). In at least one embodiment, the human searcher desiring to increase his or her profit can do so by recruiting at least one sponsoree, as the sponsor earns compensation for a sponsoree that the sponsor may introduce to the system.

To assist with his or her recruiting efforts, the human searcher (e.g., 710(f)) may create his or her personal blog, for example, blog website 820. In such an instance, a member of Cyberspace for example, operating the for-profit lower level computer system 810, may access the searcher's blog website 820. The blog website 820 may include a hyperlink in the vicinity of an advertisement that reads, “Earn money as a human searcher”. Upon activating the hyperlink, the member can be directed to the website of the search system of the provider, where the member can be registered with the information search system as a human searcher.

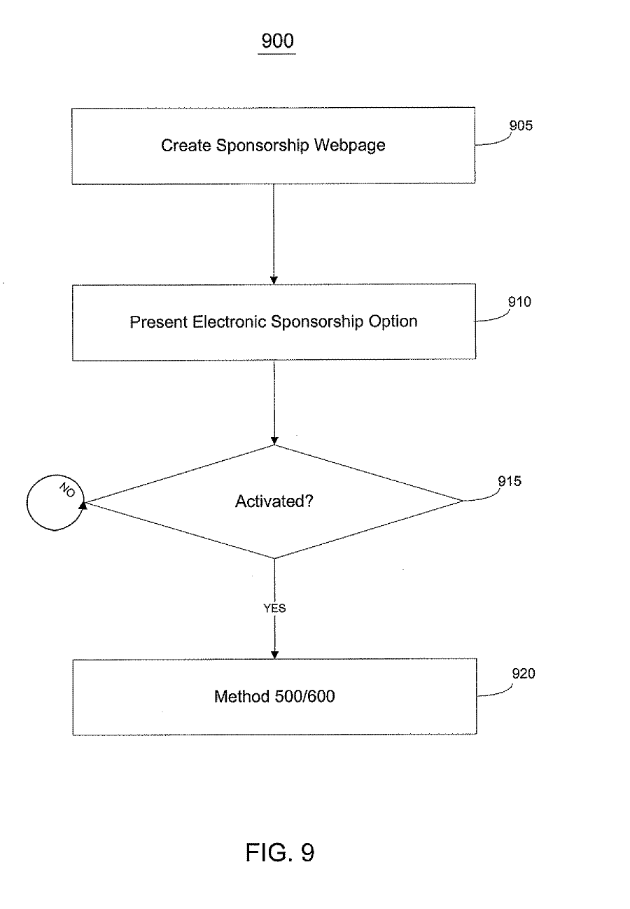

As illustrated in FIG. 9, a method 900 for sponsoring human searchers in an information search system is illustrated according to one specific embodiment.

In operation 905, a sponsorship webpage is conventionally created on a website of a sponsor. For example, the page may be created on the personal blog website 820 (FIG. 8) of a human searcher using information provided by the search system provider. The page will allow a visitor of the website to become associated with a sponsor indicated by a sponsor identifier which may be automatically associated with a registration request, as previously described herein. Control is passed to operation 910 and method 900 continues.

In operation 910, an electronic sponsorship option, for example, a button, is presented on a website, such as the blog website 820 or the non-profit organization website 825, to allow a human searcher to elect to be associated with a sponsor. For example, a human searcher can “click on” an electronic sponsorship button labeled, “Benefit the National Kidney Foundation”. Control is passed to operation 915 and method 900 continues.

In operation 915 a determination is made whether a sponsorship election has been made. If it is determined that an election has not been made, method 900 waits for an election to be made. If it is determined that a sponsorship election has been made control is passed to operation 920 and method 900 continues.

In operation 920, a registration process such as in method 500 and/or method 600 is executed. The human searcher is directed to a membership application webpage to register with the search system. In other words, the human searcher is allowed to become a human searcher and income can be shared between a human searcher and the sponsor determined in operation 915.

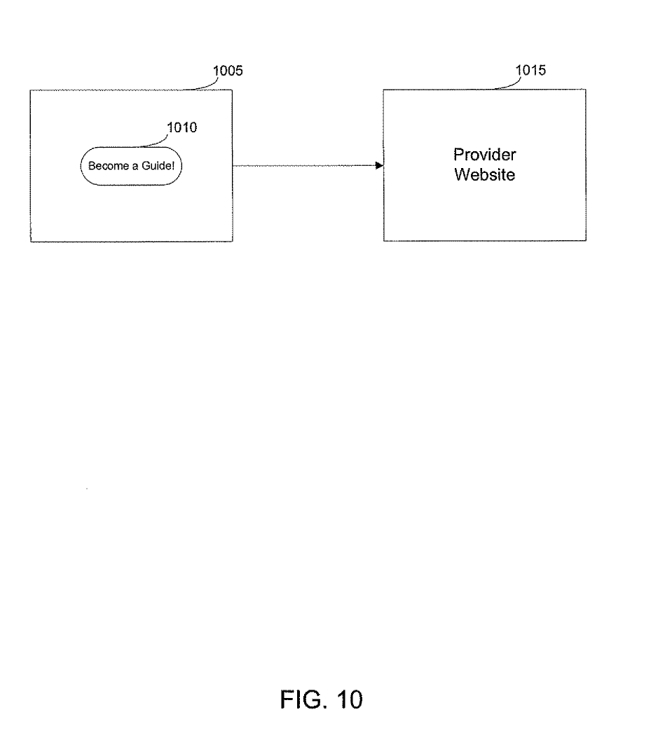

As illustrated in FIG. 10, a personal blog website 1005 (e.g., blog website 820 (FIG. 8) includes electronic sponsorship button 1010 entitled, “Become a Guide!”. Upon activating the electronic sponsorship button 1010, the human searcher is directed or transferred to provider website 1015, that is, the website of the search system provider. The human searcher is then indoctrinated into the system and automatically associated with the hosting guide's sponsor ID number (i.e., the blogger's sponsor ID number) according to at least one embodiment.

In at least one embodiment method 1100 is provided to register human searchers as for-profit and not-for-profit with the search system which may be included in the work system server 805 (FIG. 8).

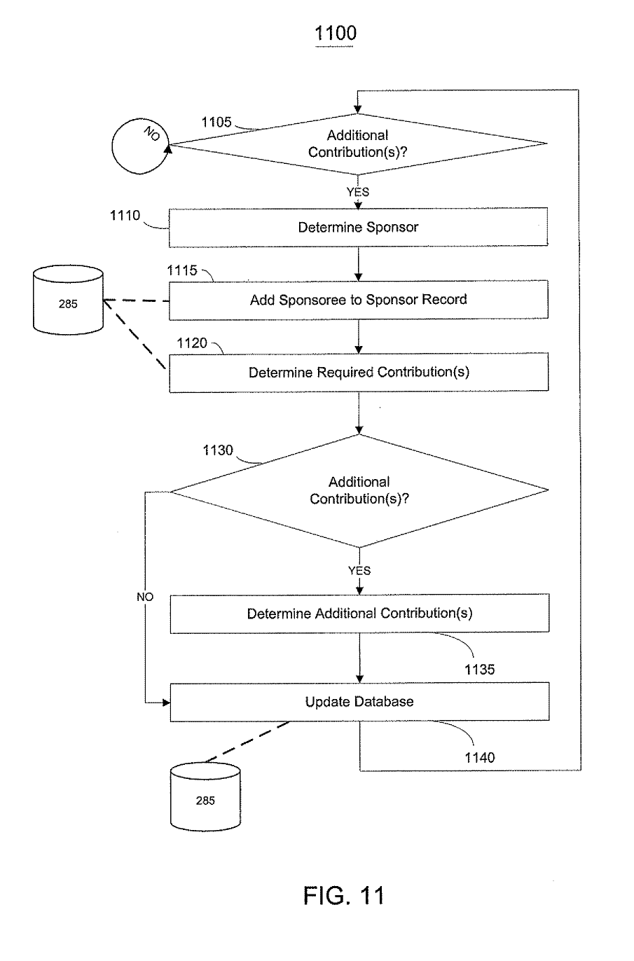

As illustrated in FIG. 11, in operation 1105, a determination is made as to whether a sponsored registration request is received by the work system server 805. For example, a visitor of a blog may access the website of the provider via an electronic “sponsorship” button on the website of the blog in at least one embodiment. Similarly, a visitor of a website of a charitable organization may access the website of the search system via an electronic “sponsorship” button on the website of the charitable organization. If it is determined in operation 1105 that no registration request is received, method 1100 waits for a registration request. If it is determined that a request is received, control is passed to operation 1110 and method 1100 continues.

In operation 1110, a sponsor identifier is received, for example via a Uniform Resource Locator (URL) by the search system and the sponsor of the entity being registered is determined, Control is passed to operation 1115 and method 1100 continues.

In operation 1115, the sponsoree, that is, the entity being sponsored, is added to the sponsor record. For example, the blog visitor would be added to the list of guides being sponsored by the blogger. The charitable website visitor would be added to the list of searchers being sponsored by the charitable organization. Control is passed to operation 1120 and method 1100 continues.

In operation 1120, a determination is made regarding the required contribution for the sponsoree to contribute to the sponsor as discussed in relation to method 600 (FIG. 6). For example, in at least one embodiment, the required contribution for some types of sponsors may be ten percent of the sponsoree's earnings. Control is passed to operation 1130 and method 1100 continues.

In operation 1130, a determination is made regarding whether a sponsoree elects to contribute an additional amount to the sponsor and/or other donees. If it is determined in operation 1130 that a sponsoree elects to contribute an additional amount to his or her sponsor and/or other donees, control is passed to operation 1135 and method 1100 continues. If it is determined that a sponsoree does not elect to contribute an additional amount, control is passed to operation 1140 and method 1100 continues.

For example, a sponsoree of a charitable organization may wish to contribute one hundred percent of his or her earnings to the charitable organization. In contrast, a sponsoree of an individual searcher employed by the search system provider may not wish to contribute an additional portion of his or her earnings to his or her sponsor.

In operation 1135 the amounts of any additional contributions to the sponsoree and/or other donees are determined, as well as the for-profit status of the sponsoree. For-profit or non-profit status is determined based upon the additional contribution decisions made by the sponsoree in operation 1135. If a sponsoree elects to contribute 100% of his or her earnings to a non-profit sponsor and/or donees he or she may be determined to be non-profit. If a sponsoree contributes less than 100% of earnings, or the sponsoree contributes earnings to a for-profit sponsor and/or donee, the sponsoree may not be considered as non-profit. Control is passed to operation 1140 and method 1100 continues.

In operation 1140, the donor/sponsoree records and the donee/sponsor records are updated to reflect for-profit/non-profit status, control is passed to operation 1105 and method 1100 continues.

Thus, the sponsor and sponsoree can be paid, that is, a percentage of the sponsoree earnings can be distributed, according to the results of the determinations described above. In addition, for-profit/non-profit status can be determined for a donor/sponsoree.

After being presented with the disclosure herein, one of ordinary skill in the art will realize that the method described in FIG. 11 can be implemented with the assistance of various records including various fields, for example, the records depicted in FIGS. 3 and 4.

The previously described methods envision that a sponsoree member of the multi-level marketing system may be obligated to make a mandatory contribution of a percentage of income generated through the multi-level marketing system to its sponsoring entity and may make additional voluntary contributions to its sponsor entity.

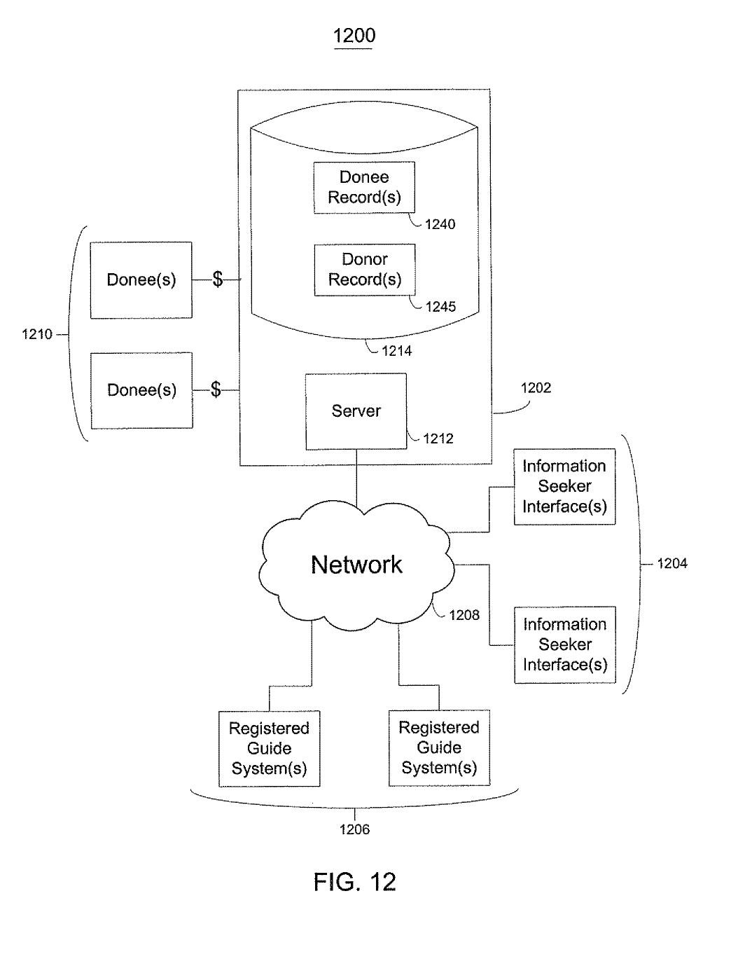

However, as shown, for example, in FIGS. 12 through 15, in one embodiment of the disclosed multi-level marketing system, members of the marketing system can elect to make voluntary contributions of income earned through the system to entities other than the members sponsor. Thus, a donee may be designated to be a recipient of a portion of the income generated by a member of the multi-level marketing system. While this method has applicability to any multi-level marketing system, the method will be described with reference to a search system whereby human searchers register with the search system to aid information seekers submitting queries to the search system and who receive results that are responsive to their queries.

As shown, for example, in FIG. 12, the multilevel marketing system 1200 comprises a search system 1202, information seeker interfaces 1204, registered guide systems 1206, a network 1208 and donees 1210. The search system 1202 includes a computer system such as a server 1212 for facilitating interaction with persons accessing the system via the network 1208 and memory 1214 for storing data related to registered searchers and donees which data includes, but is not limited to donee records 1240 and donor records 1245. The search system 1202 may store other data that will facilitate operation of the system such as data related to information seekers utilizing the search system 1202 using the information seeker interfaces 1204, and guides providing search services using the registered guide systems 1206. The information may include queries previously submitted to the search system, results generated for previously presented queries and other information as described more fully in the related U.S. application Ser. No. 11/336,928, previously mentioned.

The donee records 1240 are similar to the sponsor records 260 (FIG. 4) and donee records 240 (FIG. 3) previously described above. The donee records 1240 (FIG. 12) may be maintained in addition to, or as an alternative to, the sponsor records 260 and donee records 240. The donee records 1240 envision that income producing members of the multi-level system 1200, such as registered guides, are permitted to elect to contribute a portion of the income generated via the multi-level marketing system 1200 not only to their sponsor entity but also to other donees. Donees may have no affiliation with the search system 1202 other than being the beneficiary of voluntary contributions of registered searchers and/or other donors. Additionally, donee records 1240 envision that persons other than registered searchers using registered guide systems 1206 may seek to contribute to the donees via the system. For instance, a donor may elect to contribute a percentage of the income generated through the system to a donee. For example, an information seeker(s) accessing the search system 1202 using the information seeker interface(s) 1204 may elect to make contributions to a donee via a pledge, credit transaction or by designating that a portion of revenues generated as a result of his or her utilization of the search system 1202 be contributed to a donee.

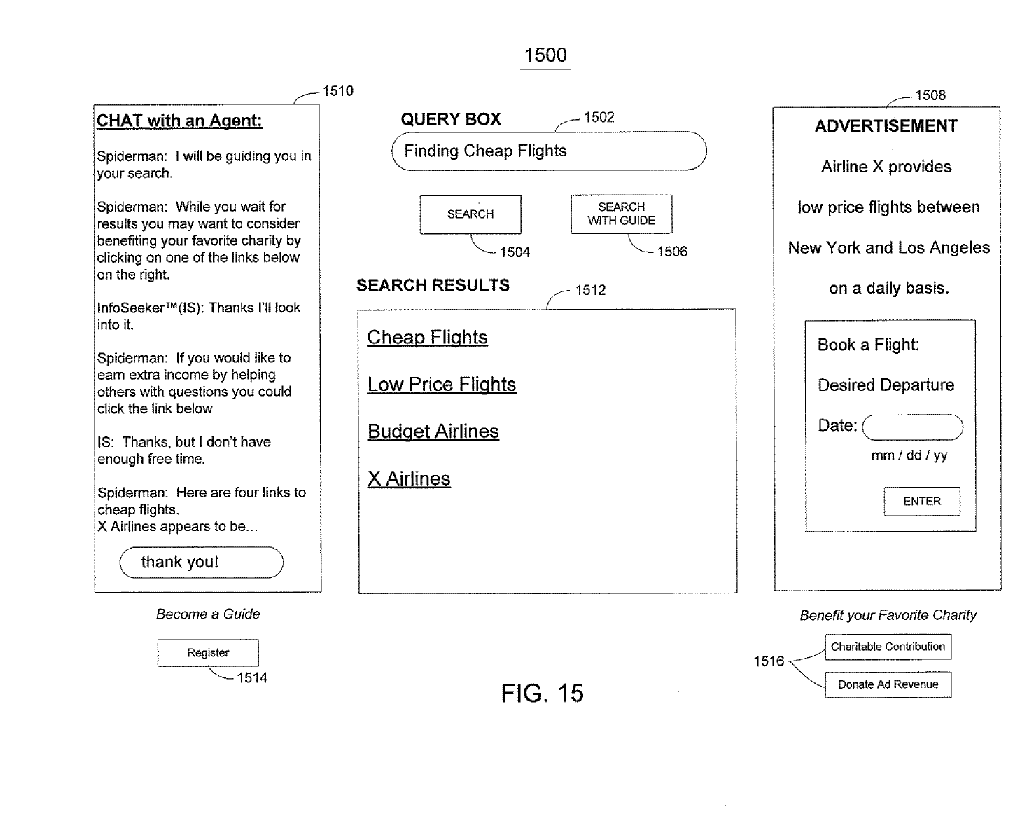

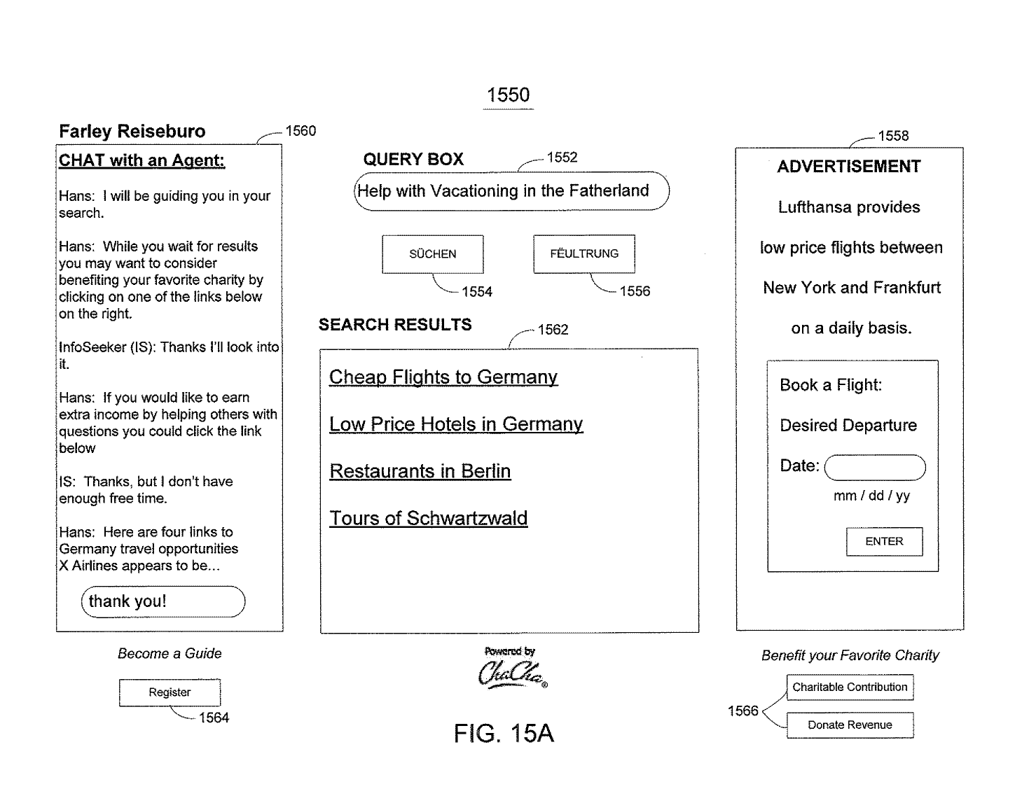

FIG. 15 illustrates an exemplary GUI 1500 presented to an information seeker utilizing the search system 1202 (FIG. 12) using an information seeker interface 1204. The GUI 1500 (FIG. 15) includes a query box 1502, a search button 1504 for requesting searching without a guide, a search with guide button 1506 for requesting searching with a guide, an advertisement window 1508, a chat window 1510, a search results window 1512, a link to become a registered guide 1514 and action buttons 1516 to make a charitable contribution(s). The functionality of the query box 1502, search button 1504, search with guide button 1506, the advertisement window 1508, chat window 1510 and results window 1512 are described more fully in U.S. application Ser. No. 11/469,732, entitled “A Search Tool Providing Optional Use of Human Search Guides”, by Jones, et al., filed Sep. 1, 2006, which is incorporated herein by reference. By selecting the link to become a registered guide 1514, information seekers may be directed to a registration webpage for registering as a guide with the search system 1202 (FIG. 12). During the registration process, the guide may designate that he or she wishes to contribute any or all of his or her earnings to donees of the multi-level marketing system 1200. By selecting the charitable contribution links via the action buttons 1516 (FIG. 15), a user may be presented with an option to make a donation to a donee through a pledge or credit transaction or to contribute a portion of revenues generated for example through their interaction with the advertisement window 1508, or other forms of revenue producing activities. to a donee. The action elements in GUI 1500 may be presented in alternate ways which are well known within the relevant art within the scope of the disclosure including, but not limited to, opening a separate browser window providing the options, generating a pop-up window with an appropriate check list and panes for entering the amount of a contribution and indicating a desired donee to which the contribution is to be made, etc.

For example, a donee may present a search GUI on a webpage provided by a server operated by the donee. When accessed for example, through such a search engine interface on a non-profit organization's webpage, the charitable contribution action buttons 1516 and/or the link to become a registered guide 1514 may only provide the option of making a charitable contribution to or being sponsored as a guide by the organization from which the search GUI page was provided.

One of ordinary skill in the relevant art will immediately recognize that a similar search GUI may be presented to an information seeker who accesses the search system through a search engine GUI on the webpage of a registered member of the search system 1202 (FIG. 12) which may be for example a company, an organization, an individual, etc.

For example, FIG. 15A illustrates an exemplary GUI 1550 provided to an information seeker utilizing the search system on the webpage of an affiliate member of the search system (e.g., a travel agent group). The GUI 1550 includes a query box 1552, a “süchen” (search) button 1554 for requesting searching without a guide, a “fëultrung” (guide) button 1556 for requesting searching with a guide, an advertisement window 1558, a chat window 1560, a search results window 1552, a link to become a registered guide 1564, action buttons 1566 to make a charitable contribution(s), donate advertisement revenue, etc and a search system branding text or icon (e.g., “Powered by ChaCha®”).

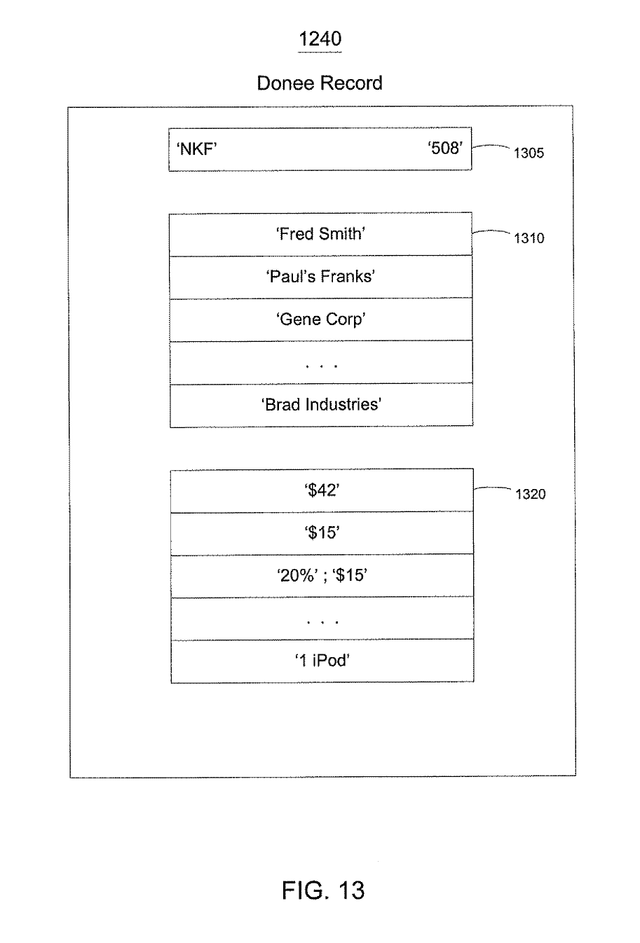

As illustrated in FIG. 13, in at least one embodiment, the donee record 1240 (FIG. 12) includes a donee identifier field 1305, donor identifier field 1310 and donor pledge field 1320. It should be noted that a donee database can be substituted for a record structure in at least one embodiment.

The donee identifier field 1305 may store data for identifying a donee, for example, “NKF 508”. A donee may also be an individual donee responsible for “signing-up” or sponsoring a sponsoree(s). Thus, while only one donee record 1240 is illustrated in FIG. 13, it is envisioned that a separate donee record 1240 may be maintained by the search system 1202(FIG. 12) for each entity recognized as a donee. In such a scenario, the data contained in the donee identifier field 1305 serves to distinguish the donee record 1240 associated with a donee from the donee record associated with other donees.

The donor identifier field or record 1310 includes data identifying donors to the donee. In one embodiment, the donor may be, for example, an individual who accessed the website of the “NKF” and followed a link thereon to register as a guide, thereby becoming a sponsoree of the organization. As explained above, a donor may be a member of the system that has elected to voluntarily contribute a portion of his or her compensation earned or donations received through the search system 1202. A donor may be an information seeker who has elected to voluntarily contribute to a donee via a pledge or donation link such as by action buttons 1516 (FIG. 15).

The donor pledge field 1320 may include a dollar amount of a contribution pledged by a sponsoree of the donee and/or from other donors. For example, an individual guide “Fred Smith” may pledge forty-two dollars to the “NKF”. In such an instance, the pledge to donee of the donor pledge field 1320 corresponding to “Fred Smith” would specify “$42” dollars. The donor pledge field or record 1320 contains multiple fields each of which is linked to the appropriate field in the donor identifier field or record 1310 so that the contribution of each donor to the donee can be determined.

After being presented with the disclosure herein, one of ordinary skill in the art will realize that other fields may be present in the donee record 1240. For example, in at least one embodiment, the record can include a donee profit status field, which specifies whether the donee is a for-profit entity or a non-profit entity.

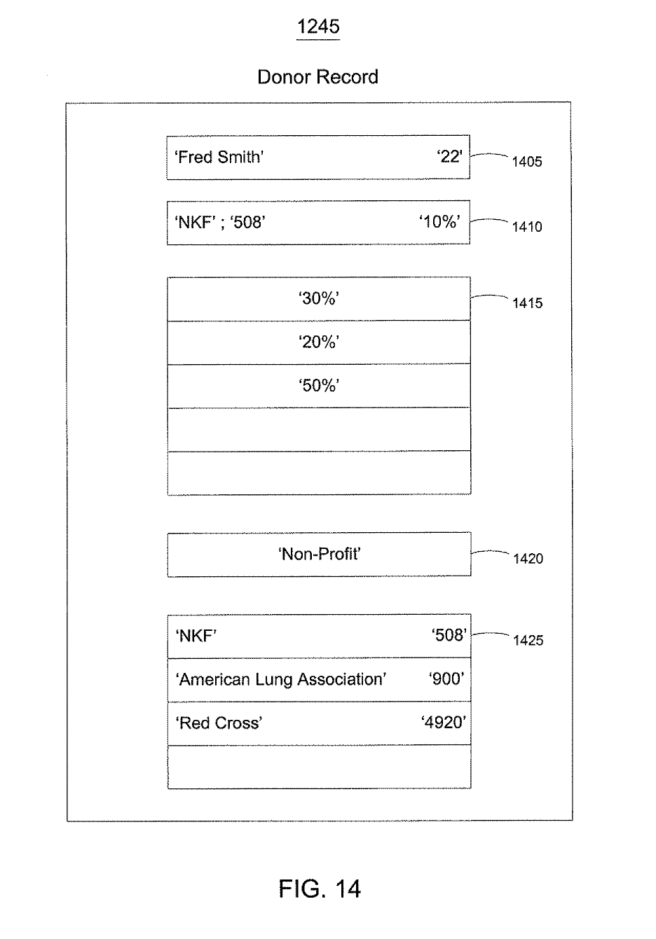

As illustrated in FIG. 14, in at least one embodiment, donor record 1245 (FIG. 12) can include a record having donor identifier field 1405, a required system mandated sponsoree contribution pledge field 1410, additional elected donor contribution pledge fields or record 1415, a donor profit status field 1420, and donee identifier fields or record 1425. It should be noted that a donor database can be substituted for a donor record structure in at least one embodiment.

The donor identifier field 1405 contains data identifying a particular donor, as previously explained (e.g. ‘Fred Smith 22’). While only one donor record 1245 is illustrated in FIG. 14, it is envisioned that a separate donor record 1245 may be maintained by the search system 1202 (FIG. 12) for each donor. In such a scenario, the data in the donor identifier field 1405 (FIG. 14) serves to distinguish the donor record 1245 associated with a donor from the donor records 1245 associated with other donors.

In at least one embodiment, a sponsoree is required to pledge or contribute an amount of his or her earnings to his or her sponsor, and the required contribution information is stored in the system mandated sponsoree contribution pledge field 1410. For example, ‘NKF; 508’ ‘10%’, to indicate the sponsor and the required percentage.

The donor profit status field 1420 (FIG. 14) includes a profit status for a particular donor. For example, if the sponsoree voluntarily elected to contribute only a portion of his or her earnings, in addition to the requisite portion, the sponsoree would be considered a for-profit donor, as he or she earns a profit for his or her work. Alternatively, if the sponsoree elected to contribute all of his or her earnings to non-profit donees, the sponsoree would be considered a non-profit donor, as he or she does not earn a profit for his or her work.

The donor contribution pledge fields or record 1415 indicate contributions to the donees in the donee identifier fields. In at least one embodiment, the donor contribution pledge 1415 fields are linked by for example a pointer to the donee identifier fields 1425. In the embodiment where a donor is able to select donees other than the sponsor, the donee identifier fields 1425 identify the other donees, as illustrated in FIG. 14.

The donee identifier fields or record 1425 contains data that identifies the one or more donees to which the donor is making contributions. In an embodiment that allows a donor to make donations to more than one donee, the donee field contains multiple fields with each field identifying a particular donee and being linked to an appropriate field in the elected donor contribution pledge fields 1415.

In at least one embodiment, voluntary contributions may be made to the sponsor, and/or to other donees as illustrated in FIG. 14.

It is envisioned that some entities may be sponsored to become non-guide members of the multi-level marketing system 1200 (FIG. 12). For example, in one embodiment, a registered guide seeking to expand his or her sponsorship network may sponsor a charitable organization or a for-profit fundraising organization to become a non-guide donee member of the system 1200. A non-guide member of the system can then act as a sponsor for other non-guide members of the system and/or for registered guide members of the system using methods described herein.

In one embodiment, to become a non-guide member of the system 1200, the non-guide member is required to promote membership in the system. Such promotion may include maintaining a link on the non-guide member's webpage for directing persons interested in becoming guides to a guide registration page on a webpage maintained by the search system 1202. Alternatively, a non-guide member may promote the search system 1202 by maintaining a membership link on their webpage for registering charitable organizations to become donees of the system. In yet another embodiment, the requirement of promoting the search system 1202 (FIG. 12) is satisfied by maintaining a search engine link on the non-guide member's webpage whereby visitors to the webpage can perform searches utilizing the search system 1202. Such links are preferably created by the search system provider and made available for download to registered members of the system 1200 for incorporation into the registered member's webpage. A non-guide member of the system 1200 may also promote the search system through references to the search system 1202 in printed, visual, audio or multi-media promotional materials. Such references may include providing appropriate URLs or phone numbers, or other information for accessing the search services provided by the search system 1202 or for registration as a guide for the search system 1202 or for registration as a non-guide member of the system 1200.

As described above, a sponsoree may voluntarily elect to contribute an additional portion of his or her earnings from the multi-level marketing system to its sponsor. This feature is available to all sponsorees in the multi-level marketing system 1200 regardless of whether they are sponsored as registered guides of the search system 1202 or as non-guide members of the multi-level marketing system 1200. The multi-level marketing system 1200 allows any registered member to voluntarily elect to contribute an additional portion of its earnings from the multi-level marketing system 1200 to any donee of the system. As mentioned above, information seekers utilizing the search system 1202 may be presented with an opportunity to voluntarily contribute money to a donee of the system 1200 either through a pledge, a credit transaction or by indicating that a portion of the revenue generated by an interaction with advertisements presented on a search results webpage should be contributed to a designated donee. Also, as mentioned above visitors to the webpage of a member of the system may be provided with a link, similar to links or action buttons 1516 (FIG. 15) on the GUI 1500, whereby the visitor can elect to donate money to a donee of the system through for example a pledge or a credit transaction. These voluntarily elected contributions are reflected in the donor record 1245 (FIG. 14), which contains multiple fields for maintaining data regarding the donees and the amount that the donor has elected to contribute to each donee.

It is within the scope of the disclosure for a registered member(s) of multi-level marketing system 1200 (FIG. 12) to utilize method 500 (FIG. 5) for recruiting human searchers. It is also within the scope of the disclosure for a registered member to include links on his or her blog to allow entities visiting the blog to register as non-guide members of the multi-level marketing system 1200.

As a result of the system and method described above, a marketing operation can be conducted in which each entity of a particular level is sponsored by an entity of a higher level. However, the system and method described above facilitates making contributions of income generated from the multi-level marketing system 1200 to other registered members of the system 1200 regardless of the level at which the other registered member is located in the system and regardless of whether the other registered member is in the same sponsorship branch of the system 1200 as the donor. As a result of the mixture of both for-profit entities and non-profit entities, a more global marketing approach can be experienced, thereby resulting in the potential for increased profits to the profit-earning entities and increased revenues for charitable organizations.

It is within the scope of the disclosure for registered members of the system 1200 to utilize method 600 (FIG. 6) as described above to recruit members for the system 1200. For example, a non-profit lower level donor may wish to contribute one hundred percent of its earnings to one or more donees. In contrast, a for-profit lower level donor may not wish to contribute any additional amount over the requisite amount to its sponsor and/or donee(s). In at least one embodiment, the donor is presented with a graphical user interface (such as the GUI 2000 (FIG. 16)) prompting the donor for his or her selection regarding additional elective contributions

It is also within the scope of the disclosure for each registered member of the system to receive a notification when new donees are added to the system and be presented an opportunity to modify their voluntary contribution amounts and/or donee(s) to which voluntary contributions are to be made.

While the multi-level marketing system 1200 (FIG. 12) has been described with reference to a search system wherein registered guides are compensated for aiding information seekers in obtaining results to queries submitted to a search system 1202, it is within the scope of the disclosure for multi-level marketing system to be implemented in other multi-level marketing plans wherein task workers perform tasks to earn income.

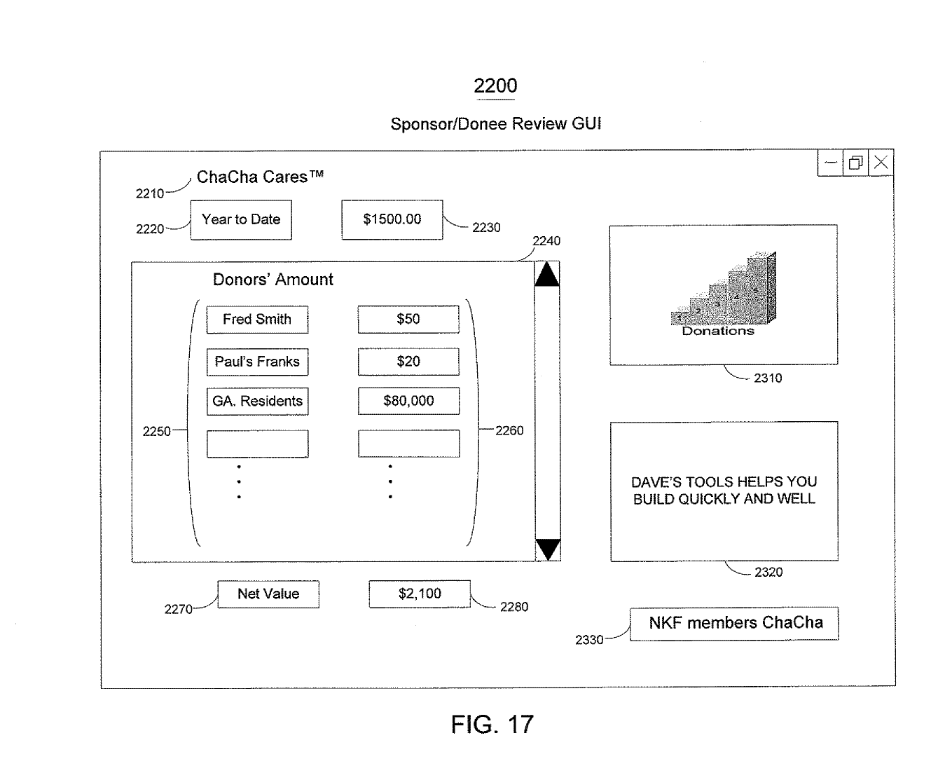

As the multilevel marketing system has been described in the context of an information search system, the system may use some of the aspects of the search system database to facilitate revenue enhancement for the search system provider, and for members of the multi-level marketing system. This may be accomplished using the GUI's illustrated in FIGS. 16 and 17.

The GUI in FIG. 16 is a sponsoree/donor election GUI. In one embodiment, the GUI is presented to an income producing member of the multi-level marketing system in order to allow the member to make additional voluntary contributions to a sponsor and/or other donees, and to elect to be a non-profit donor. This may be done during registration by selecting to contribute 100% of earnings to a non-profit donor, as describe herein with respect to FIG. 11. In another embodiment, the GUI may be presented to a worker who has accrued earnings but has not been paid. In that embodiment, the donor may elect to contribute any or all accrued earnings to designated donees. This may allow the donor and donee to realize greater benefit due to the ability to perform tasks to achieve a goal designated by the donor for a contribution to a donee.

Because the multi-level marketing system may be part of a human assisted search system, the search system database may be used to augment the marketing system. By using features of the GUI, a donor may be able to locate information regarding donees aligned with his or her interests. This may increase revenues for the donees, and for the search system provider.

The GUI illustrated in FIG. 17 may be used by donees for multiple purposes. In its simplest form, the GUI allows a donee to evaluate the performance of donors, and contact them to discuss goals and or specific needs. The GUI may allow a donee to examine its donor base to determine demographics of the donors, based on profile information stored in the search system. This may facilitate location of similar donors within the marketing system.

The search system may also allow donors and/or donees to target advertising to each other based on profile information which may be available in the search system or the tracking system. This may allow the search system provider to maximize revenues from advertising, and the donors/donees to bid for targeted advertising. Due to the anonymous communication capability of the search system, as further described in the related U.S. application Ser. No. 11/779,502 entitled, “Anonymous Search System Using Human Searchers”, by Jones, et al., filed Jul. 18, 2007 incorporated herein by reference, donors may be contacted without revealing personally identifying information.

An exemplary sponsoree/donor election graphical user interface (GUI) is illustrated in FIG. 16. The sponsoree/donor election GUI 2000 may be presented to a registered guide or member either during the registration process, or optionally on demand of the guide or registered member. System contribution text 2010 may be displayed to indicate that the system is providing income to the sponsor (e.g., “ChaCha Cares™”). The sponsor ID indicator 2020 and mandatory contribution(s) indicator 2030 may indicate the sponsor name (e.g., “NKF”) and contribution level (e.g., “$20 in your name”) made to the sponsor by the system and/or the donor. In the case where the system provider is paying the commission, this may serve to promote goodwill with the donor as the system provider is augmenting contributions.

Elective contribution(s) window 2040 may appear to allow the donor to elect to make additional contributions that may be to donees including but not limited to the sponsor of the donee. As illustrated in FIG. 16, the donee ID fields 2050 and donee pledge fields 2060 indicate a donee ID (e.g., “NKF”) and a donee pledge (e.g., “30%=$”), respectively. The donee ID fields or indicators 2050 may be text entry boxes or preferably drop-down lists of donees which may be presented based on information such as keywords, profiles, etc. associated with the donor and/or existing donees. This may help donees obtain contributions as their objectives may be aligned with those of the donor who might otherwise keep those earnings, or donate to another cause.

The donee ID fields 2050 may be linked to a selection GUI to allow a donor to locate donees more rapidly using the search system capabilities.

The donee pledge fields 2060 may reflect a percentage of earnings, as previously described, a dollar amount, or another goal item which the donor has selected. The pledge(s) may allow a donor to achieve non-profit status by allocating earnings as previously described. Calculations of earnings such as total contributions, contribution summary, etc. may be selected using the calculation entry box 2070. The calculated results may be presented in the results box 2080.

Progress toward a goal of the donor or the donee and/or other graphics may be displayed in the graphics window 2110. For example, a donee might wish to determine the number of revenue producing searchers who contributed to a given donor in order to target advertising to a group(s).

A targeted advertisement(s) may be displayed in the advertising window 2120. Targeting may be based on keywords, profiles, categories, etc. associated with the donor and/or donees using various methods. A message window 2130 may be provided to allow the system and/or a donee to communicate with the donor via a chat or message board facility. Notification of new donees of interest might appear here, for example.

Accept and cancel buttons 2090 and 2100 may be used to exit the GUI and save or cancel changes to the donor record such as the donor record 245 (FIG. 3) described herein.

An exemplary sponsor/donee review graphical user interface (GUI) is illustrated in FIG. 17. The GUI 2200 may be presented to a donee/sponsor at any time to allow review of donors or sponsorees associated with a donee record such as the donee record 240 (FIG. 3).

The system ID field 2210 indicator may indicate the paid by status. In the case where the system provider is underwriting the commission, this may be indicated. The text box 2220 may be used to indicate the period and/or other data of the contributions made by the system. The results box 2230 may indicate the contribution value.

The donor information window 2240 may display information regarding donors of the donee, as recorded in the donee record. As the donors may be anonymous, or may be many, the donor selection fields 2250 may include options for selecting a donor(s) to be displayed. For example, the donor names might be a group of donors, and/or a drop-down list, or other means to select a group of donors with a common affiliation (e.g., from the same city) might be presented. In this way, the donee may be able to evaluate the donor base more effectively in order to improve donations. Likewise, a sponsor might select sponsorees with various levels of performance, or locations, etc.

Graphical representations of selected data may be presented in the graphics window 2310. For example, comparisons of contributions by various demographics might be displayed. These might enable the donee to better target advertising and/or appeals, and increase contributions for the donee as well as generate revenue for the system provider.

Targeted advertisements may be displayed in the advertising window 2320. The donee may communicate with sponsorees and/or donors via the message box 2330. Calculation types may be selected in the operation box 2270. Results of the calculations may be displayed in the data box 2280.

The elements of the GUI's 2000 and 2200 may be presented in various ways known in the art without departing form the spirit of the disclosure.

After being presented with the disclosure herein one of ordinary skill in the art will realize that the embodiments described herein can be implemented in software, firmware, and/or a combination thereof. Program code according to the embodiments described herein can be implemented in any viable programming languages such as C, C++, JAVA, XML, HTML, or any other viable high-level programming language, or a combination of such a high-level programming language and a low-level programming language such as Assembler, for example.

The embodiments described herein can also be in the form of a computer readable storage or medium encoded with processing instructions for controlling a computer to implement the methods described herein.

The embodiments described herein should not be limited to the embodiments described herein. After being presented with the disclosure herein, those of ordinary skill in the art would appreciate that changes may be made to the disclosed embodiments without departing from the spirit and scope of the described embodiments.

What is claimed is:

1. A method of multi-level marketing, comprising:
automatically sharing income between at least one higher level including at least one for-profit entity, a middle level including at least one for-profit entity, and
at least one income producing level including a mixture of non-profit entities and for profit entities.

2. The method of claim 1, wherein said sharing includes providing a middle level marketing entity with a percentage of earnings earned by a recruit of the middle level marketing entity.

3. The method of claim 2, further comprising receiving an indication of whether one of the entities in the levels wishes to donate an additional portion of the entity's earnings to one of the non-profit entities.

4. The method of claim 1, further comprising:
determining a sponsor after a new entity of the income producing level is identified.

5. The method of claim 3, further comprising:
receiving a sponsor identification code corresponding to the sponsor along with identification of the new entity.

6. The method of claim 1, further comprising:
providing an option for a new income producing entity to donate at least a portion of earnings to one of the non-profit entities when the new income producing entity learns of an entity of the intermediate level without having been directed to the entity of the intermediate level by the entity of the marketing level.

7. A method for recruiting human searchers in an information search system, comprising:
associating a human searcher with a sponsor; and
sharing compensation between the human searcher and the sponsor.

8. The method of claim 7, wherein said sharing includes determining recruitment
compensation for the sponsor based on a multi-level marketing structure having at least one middle marketing level including at least one for-profit entity, a higher level including at least one for-profit entity; and at least one income producing level including a mixture of non-profit entities and for-profit entities.

9. The method of claim 8, wherein said determining includes compensating the sponsor with a percentage of income associated with the human searcher.

10. The method of claim 8, wherein said determining includes providing the human
searcher with a choice regarding allocation of the income associated with the human searcher.

11. The method of claim 10, wherein the human searcher and the sponsor are provided with a verification notification to ensure that both parties are mutually aware of their relationship.

12. The method of claim 10, wherein the choice regarding allocation of the income associated with the human searcher includes distribution of earnings to the sponsor when the sponsor is one of the non-profit entities.

13. The method of claim 7, wherein said associating includes:
presenting an option on an interactive information product about the sponsor to allow the human searcher to be associated with the sponsor when conducting searches; and
automatically associating the human searcher with the sponsor when the option is selected by the human searcher.

14. The method of claim 13, wherein a sponsor identifier identifying said sponsor is encrypted.

15. The method of claim 13, wherein said presenting includes associating the human searcher with an identifier of the sponsor.

16. The method of claim 13, wherein the membership page includes a second option to donate earnings of the human searcher to the sponsor when the sponsor is a non-profit organization.

17. A computer-readable medium storing instructions that when executed cause a computer to perform a method comprising:
associating a human searcher with a sponsor; and
sharing compensation between the human searcher and the sponsor.

18. The computer-readable medium of claim 17, wherein said method further comprises:
determining recruitment compensation for the sponsor based on a multi-level marketing structure including at least one middle level including at least one for-profit entity, a management level including at least one for-profit entity, and at least one income producing level including a mixture of non-profit entities and for-profit entities.

19. A method, comprising:
performing a web-based income producing task at an income producing level; and
automatically sharing income between at least one higher level including at least one for-profit entity, a middle level including at least one for-profit entity, and at least one income producing level including a mixture of non-profit entities and for profit entities.

20. A computer readable storage for controlling a computer including
a sponsor record, comprising:
a sponsor identification field;
a sponsoree identification field; and
an earnings field.

21. A system, comprising:
a search computer system adapted to transmit search queries; and
at least one website interface communicatively coupled to said search computer system to allow communication to occur between said search computer system and at least one other computer system or website.

22. The system of claim 21, wherein said search computer system includes a donee election graphical user interface and a donor information graphical user interface.

23. The system of claim 22, wherein the donee election graphical user interface shows to potential donor/sponsoree other causes to which the potential donor/sponsoree may wish to donate in order to become not-for-profit.

24. The system of claim 22, wherein the donee election graphical user interface delivers targeted appeals to donors/sponsorees in a graphics window when needs arise.

25. The system of claim 22, wherein the donor information graphical user interface displays a top number of contributors contributing most to a given cause.

26. The system of claim 22, wherein the donor information graphical user interface delivers targeted advertising to a donee from a donor organization that is for-profit who is on said donee's top number of contributors selection in the donor information graphical user interface.

27. The system of claim 22, wherein the donee election graphical user interface delivers a targeted advertisement to a donor in a graphics window that is based on a selected donees list included in the donee election graphical user interface.

28. The system of claim 22, wherein the donor information graphical user interface illustrates where a given donor/sponsoree ranks graphically using a graphics window.

29. The system of claim 22, wherein the donee election graphical user interface includes a window displaying total contributions in percentages and/or monetary amounts.

30. The system of claim 22, wherein the donor information graphical user interface and the donee election graphical user interface include fixed fields.

31. The system of claim 22, wherein the donee election graphical user interface can be utilized to liquidate any net earnings at year-end.

32. A search computer system adapted to transmit search queries and allow users to be sponsored; and at least one website interface communicatively coupled to said search computer system to allow communication to occur between said search computer system and at least one other computer system or website, said search computer system
providing sponsorship and receiving access by a lower level member assessing the search computer system via a blog or a charitable organization,
determining a sponsor identifier by tracing a uniform resource locator used to access the search computer system,
adding sponsoree to sponsor database, determining a required contribution for sponsoree to contribute to contribute to sponsor;
adding an amount of total contribution in sponsor database,
determining whether sponsoree wishes to contribute an additional monetary amount,
adding a for-profit status to the sponsoree database if said determination yields a negative result, and when said determination yields a positive result,
determining an additional amount of sponsoree's earnings sponsoree wishes to pledge,
updating the sponsoree database with an additional contribution amount,
updating the sponsor database with an additional amount, and
adding non-profit status to the sponsoree database.

33. A method comprising;
Selecting a donee;
initiating a transfer of information to a donor of the donee; and
displaying the information to the donor.

34. The method of claim 32, wherein a price is established for said transfer.

35. A method comprising:
Selecting a donor;
identifying a donor associated with the selected donor; and
initiating a transfer of information to the identified donor.

36. The method of claim 34, wherein a price is established for said transfer.
